(19) United States
(12) Patent Application Publication
(10) Pub. No.: US 2019/0180118 A1
(43) Pub. Date: Jun. 13, 2019

(54) LOCOMOTIVE IMAGING SYSTEM AND METHOD

(71) Applicant: GE Global Sourcing LLC, Norwalk, CT (US)

(72) Inventors: Mark Bradshaw Kraeling, Melbourne, FL (US); Matthew Blair, Lawrence Park, PA (US); Shannon Joseph Clouse, Lawrence Park, PA (US); Scott Daniel Nelson, Melbourne, FL (US); Nidhi Naithani, Bangalore (IN); Dattaraj Jagdish Rao, Bangalore (IN); Anwarul Azam, Erie, PA (US); Nikhil Uday Naphade, Bangalore (IN); Jaymin Thakkar, Bangalore (IN); Ankit Sharma, Bangalore (IN); Priyanka Joseph, Melbourne, FL (US)

(21) Appl. No.: 16/278,436

(22) Filed: Feb. 18, 2019

Related U.S. Application Data
(63) Continuation-in-part of application No. 14/457,353, filed on Aug. 12, 2014.
Application No. 14/457,353 is a continuation-in-part of application No. 16/158,867, filed on Oct. 12, 2018.
Application No. 16/158,867 is a continuation of application No. 14/979,011, filed on Dec. 22, 2015, now Pat. No. 10,176,386.
Application No. 14/979,011 is a continuation-in-part of application No. 15/862,238, filed on Jan. 4, 2018.
(60) Provisional application No. 61/940,660, filed on Feb. 17, 2014.
(60) Provisional application No. 61/940,610, filed on Feb. 17, 2014.
(60) Provisional application No. 61/940,813, filed on Feb. 17, 2014.
(60) Provisional application No. 61/940,696, filed on Feb. 17, 2014.
(60) Provisional application No. 62/097,377, filed on Dec. 29, 2014.
(60) Provisional application No. 62/452,435, filed on Jan. 31, 2017.

(51) Int. Cl. G06K 9/00; B60W 40/105; G01P 3/38; G01S 11/12; G06T 7/246

(52) U.S. Cl. CPC G06K 9/00798; B60W 40/105; G01P 3/38; G01S 11/12; G08G 1/167; Y02T 10/7258; G06T 2207/30256; B60W 2420/42; G06T 7/246

(57) ABSTRACT

An imaging system includes a digital camera configured to be disposed in a locomotive system that includes a locomotive coupled to a rail vehicle. The camera generates image data within a field of view that includes a cab of the locomotive system and a portion of a route being traveled on and/or wayside devices disposed along the route. The cab includes a space where an operator of the vehicle is located. The system also can include one or more analysis processors that examine the image data generated by the camera to identify route damage, a deteriorating condition of the route, and/or a condition of the wayside devices. The condition of the wayside devices can include damage to the wayside devices, a missing wayside device, deterioration of the wayside devices, or a change in terrain.

### CROSS-REFERENCE TO RELATED APPLICATIONS

This application is a continuation in part of U.S. patent application Ser. No. 14/457,353, which was filed on 12 Aug. 2014, and is titled “Vehicle Imaging System and Method” which claims priority to U.S. Provisional Application No. 61/940,660, which was filed on 17 Feb. 2014, and is titled “Route Imaging System And Method” (the “'660 Application”), U.S. Provisional Application No. 61/940,610, which also was filed on 17 Feb. 2014, and is titled “Wayside Imaging System And Method” (the “'610 Application”), U.S. Provisional Application No. 61/940,813, which was filed on 17 Feb. 2014, and is titled “Portable Camera System And Method For Transportation Data Communication” (the “'813 Application”), and U.S. Provisional Application No. 61/940,696, which was filed on 17 Feb. 2014, and is titled “Vehicle Image Data Management System And Method” (the “'696 Application”). The entire disclosures of these applications (e.g., the '660 Application, the '610 Application, the '813 Application, and the '696 application) are incorporated by reference. This application is also a continuation in part of U.S. patent application Ser. No. 16/158,867, which was filed on 12 Oct. 2018, and is titled “Method and System to Determine Locomotive Speed” that is a continuation of U.S. patent application Ser. No. 14/979,011, filed on 22 Dec. 2015, which claims priority to U.S. Provisional Application No. 62/097,377, filed on 29 Dec. 2014, the entire disclosures of which are incorporated herein by reference. This application is also a continuation in part of U.S. patent application Ser. No. 15/862,238, which was filed on 4 Jan. 2018, and is titled “Visual Object Detection System” that claims priority to U.S. Provisional Patent Application No. 62/452,435, which was filed 31 Jan. 2017, and the entire disclosure of which is incorporated herein by reference. The entire disclosures of all of these applications (e.g., the '353 Application, the '660 Application, the '610 application, the '813 Application, the '696 Application, the '867 Application, the '011 application, the '377 Application, the '238 Application, and the '435 Application) are incorporated by reference.

### FIELD

Embodiments of the subject matter described herein relate to imaging systems, such as imaging systems onboard or near vehicle systems.

### BACKGROUND

Vehicle systems such as trains or other rail vehicles can include cameras disposed on or near the vehicle systems. These cameras can be used to record actions occurring outside of the vehicle systems. For example, forward facing cameras can continuously record video of the locations ahead of a train. If a collision between the train and another vehicle occurs (e.g., an automobile is struck at a crossing), then this video can later be reviewed to determine liability for the collision, whether the other vehicle improperly moved through a gate or signal, whether the train was moving too fast, or the like. But, the image data obtained by these cameras typically is only saved on a temporary loop. Older image data is discarded when no accidents occur, even though this image data may represent one or more other problems with the vehicle and/or track.

In order to inspect routes, wayside devices disposed along the routes traveled by the vehicle systems, or the like, crews are periodically sent out over the routes to inspect the condition of the wayside devices. This is a labor intensive and costly operation that also ties up the routes, and can interfere with regular and normal operations of other transportation using the routes. Additionally, because this is a periodic operation, a fault in the route or in a wayside device may not be observed by inspection crews in time to prevent catastrophic events.

### BRIEF DESCRIPTION

In one example in accordance with subject matter described herein, a locomotive system (e.g., an imaging system) includes a locomotive and a rail vehicle coupled to the locomotive. A digital camera is configured to be disposed in the locomotive system, the camera configured to generate image data within a field of view of the camera, the field of view including at least a portion of a cab of the locomotive system and at least one of a portion of a route being traveled by the locomotive system or one or more wayside devices disposed along the route being traveled by the locomotive system, the cab including a space where an operator of the locomotive system is located during travel of the locomotive system. The locomotive system also includes one or more analysis processors configured to examine the image data generated by the camera to identify at least one of damage to the route, a deteriorating condition of the route, or a condition of the one or more wayside devices, the condition of the one or more wayside devices including at least one of damage to the one or more wayside devices, a missing wayside device, deterioration of the one or more wayside devices, or a change in terrain at or near the one or more wayside devices.

In another example in accordance with subject matter described herein, a method is provided including generating image data within a field of view of a camera disposed onboard a locomotive system that includes a locomotive coupled to a rail vehicle, the field of view including at least a portion of a cab of the locomotive system and at least one of a portion of a route being traveled by the locomotive system or one or more wayside devices disposed along the route being traveled by the locomotive system, the cab including a space where an operator of the locomotive system is located during travel of the locomotive system. The method also includes examining, using one or more analysis processors, the image data generated by the camera to identify at least one of damage to the route, a deteriorating condition of the route, or a condition of the one or more wayside devices, the condition of the one or more wayside devices including at least one of damage to the one or more wayside devices, a missing wayside device, deterioration of the one or more wayside devices, or a change in terrain at or near the one or more wayside devices.

In yet another example in accordance with subject matter described herein, a locomotive system is provided that includes a locomotive coupled to a rail vehicle. The locomotive system also includes a digital camera configured to be disposed in the rail vehicle, the camera configured to generate image data within a field of view of the camera, the field of view including at least one of a portion of a track outside of the rail vehicle or one or more wayside devices along the track being traveled by the locomotive. The locomotive system also includes one or more analysis processors configured to be disposed onboard the locomotive and to examine the image data generated by the camera to identify a condition of at least one of the track or the one or more wayside devices, the condition including at least one of damage to the track, damage to the one or more wayside devices, a missing wayside device, or a changing condition of terrain at or near the one or more wayside devices.

### BRIEF DESCRIPTION OF THE DRAWINGS

The subject matter described herein will be better understood from reading the following description of non-limiting embodiments, with reference to the attached drawings, wherein below:

FIG. 1 is a schematic illustration of a vehicle system having a wayside imaging system disposed thereon according to one embodiment;

FIG. 2 illustrates an image representative of image data generated by a camera shown in FIG. 1 for examination by one or more analysis processors shown in FIG. 1 according to one embodiment;

FIG. 3 illustrates one example of a comparison between the image data acquired by and output from the camera shown in FIG. 1 with baseline image data according to one embodiment;

FIG. 4 illustrates another example of a comparison between the image data acquired by and output from the camera shown in FIG. 1 with baseline image data according to one embodiment;

FIG. 5 illustrates an image representative of additional image data generated by the camera shown in FIG. 1 for examination by the analysis processor shown in FIG. 1 according to one embodiment;

FIG. 6 illustrates one example of a comparison between the image data acquired by and output from the camera shown in FIG. 1 with baseline image data according to one embodiment;

FIG. 7 illustrates a flowchart of a method for imaging one or more wayside devices disposed along a route traveled by one or more vehicle systems according to one embodiment;

FIG. 8 illustrates an image representative of image data generated by a camera shown in FIG. 1 for examination by an analysis processor shown in FIG. 1 according to one embodiment;

FIG. 9 illustrates one example of a comparison between a route shown in FIG. 1 as represented by image data generated by the camera shown in FIG. 1 with a baseline route image according to one embodiment;

FIG. 10 illustrates a schematic diagram of a vehicle consist having one or more imaging systems shown in FIG. 1 in accordance with one embodiment;

FIG. 11 illustrates a top view of the vehicle consist shown in FIG. 10 according to one embodiment;

FIG. 12 illustrates a flowchart of a method for imaging a route traveled by one or more vehicle systems according to one embodiment;

FIG. 13 is a schematic illustration of a vehicle speed determination system according to an embodiment of the inventive subject matter;

FIG. 14 is a schematic illustration of a vehicle speed determination system according to another embodiment of the inventive subject matter;

FIG. 15 is a schematic illustration of a vehicle speed determination system according to another embodiment of the inventive subject matter;

FIG. 16 is a schematic illustration of image data analysis, according to an embodiment of the inventive subject matter;

FIG. 17 illustrates a single frame or image acquired by the camera shown in FIGS. 13 through 15 according to one example;

FIG. 18 illustrates a portion of the frame or image shown in FIG. 17;

FIG. 19 illustrates an image or frame obtained by the camera shown in FIG. 13 at a first time according to one example;

FIG. 20 illustrates another image or frame obtained by the camera shown in FIG. 13 at a subsequent, second time;

FIG. 21 illustrates an overlay image of part of image shown in FIG. 19 and part of the image shown in FIG. 20;

FIG. 22 illustrates an image or frame obtained by the camera shown in FIG. 13 at a first time according to one example;

FIG. 23 illustrates another image or frame obtained by the camera shown in FIG. 13 at a subsequent, second time;

FIG. 24 illustrates an overlay image of part of image shown in FIG. 22 and part of the image shown in FIG. 23;

FIG. 25 illustrates a flowchart of one embodiment of a method for determining a vehicle speed and/or heading;

FIG. 26 illustrates one embodiment of a visual object detection system;

FIG. 27 illustrates a flowchart of one embodiment of a method for detecting objects in visual data and/or determining depth of objects in visual data;

FIG. 28 illustrates one example of 2D visual data generated by an optical sensor 2604 shown in FIG. 26;

FIG. 29 illustrates one example of how a controller shown in FIG. 26 can convert the known dimension of an object in the visual data to an external scale; and

FIG. 30 illustrates additional visual data provided by the optical sensor shown in FIG. 26 according to one example.

### DETAILED DESCRIPTION

One or more embodiments of the inventive subject matter described herein relate to imaging systems and methods for vehicle systems. While several examples of the inventive subject matter are described in terms of rail vehicles (e.g., trains, locomotive, locomotive consists, and the like), not all embodiments of the inventive subject matter is limited to rail vehicles. At least some of the inventive subject matter may be used in connection with other off-highway vehicles (e.g., vehicles that are not permitted or designed for travel on public roadways, such as mining equipment), automobiles, marine vessels, airplanes, or the like.

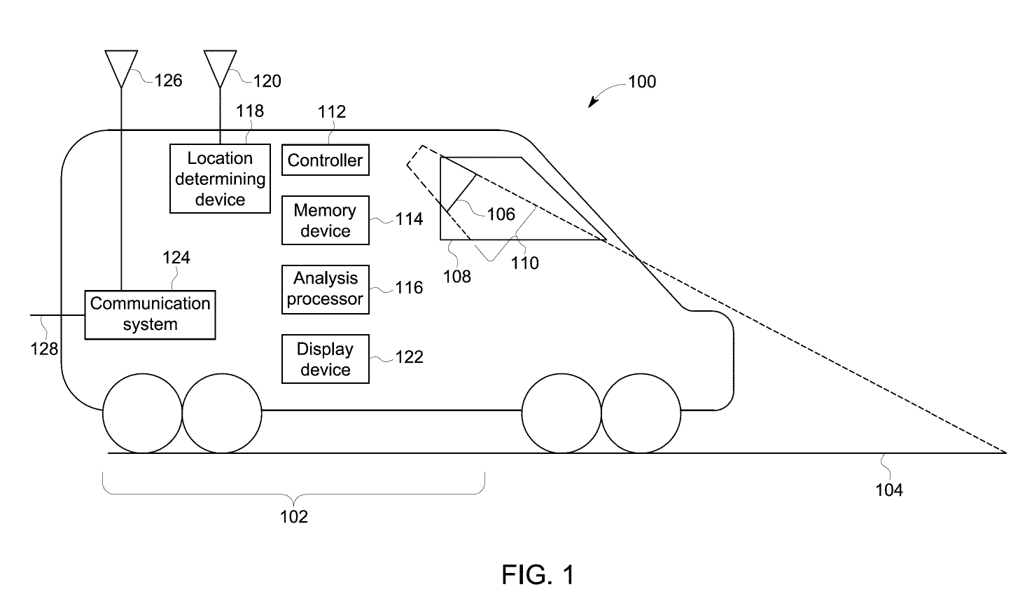

FIG. 1 is a schematic illustration of a vehicle system 100 having an imaging system 102 disposed thereon according to one embodiment. The vehicle system 100 includes a single vehicle, such as a single rail vehicle (e.g., locomotive), but alternatively may include two or more vehicles mechanically coupled with each other to travel together along a route 104, such as a train or other vehicle consist.

The imaging system 102 includes one or more cameras 106 that obtain image data of the interior and/or exterior of the vehicle system 100. The camera 106 shown in FIG. 1 is an internal or interior camera that is coupled with the vehicle system 100 so that a field of view 110 of the camera (e.g., the space that is imaged or otherwise represented by image data generated by the camera) includes at least part of an interior of the vehicle system 100. For example, the camera 106 in FIG. 1 may be referred to as a cab camera that is disposed inside a cab of the vehicle system 100 where an operator of the vehicle system 100 is located to control and/or monitor operations of the vehicle system 100.

The camera 106 can be positioned and oriented so that the field of view of the camera 106 includes the interior space of the cab in the vehicle system 100, as well as a portion of the exterior of the vehicle system 100. This portion of the exterior of the vehicle system 100 can be the space outside of the vehicle system 100 that is viewable through one or more windows 108 of the vehicle system 100. In the illustrated example, the camera 106 is oriented so that at least a portion of the route 104 that is ahead of the vehicle system 100 is viewable in the field of view 110 of the camera 106. In this way, the camera 106 can be used to both monitor events inside the vehicle system 100 and examine the route and/or wayside devices outside of the vehicle system 100, as described herein. For example, the camera 106 can be used to record performance of the operator of the vehicle system 100 to ensure that the operator is controlling the vehicle system 100 safely, according to rules, requirements, or regulations, is present and aware, and the like. The camera 106 may then also be used to determine if any external problems exist with the route and/or the wayside devices.

As described herein, one or more wayside devices also may be within the field of view 110 of the camera 106. These wayside devices include equipment, systems, assemblies, and the like, that are located outside of the vehicle system 100 at, near, or alongside the route 104. The wayside devices can provide functionality to guide, warn, examine, or otherwise assist travel of the vehicle system 100. By way of non-limiting examples, the wayside devices can include signals that display signs, illuminate lights, or otherwise visually notify an onboard operator of the vehicle system 100 of a vacancy or occupancy of an upcoming segment of the route 104, a reduced speed limit, an upcoming segment of the route 104 being repaired or maintained, or the like. The wayside devices can include examination systems that examine the vehicle system 100 as the vehicle system 100 travels past the wayside devices. Examples of such wayside devices can include cameras, infrared detectors, radio frequency identification (RFID) transponders, readers, or tags, or the like. Other wayside devices can include systems that communicate with the vehicle system 100 using wired and/or wireless connections, such as by wirelessly communicating messages to the vehicle system 100 and/or communicating messages through the route 104 (e.g., as electric signals communicated through one or more conductive rails of the route 104). Optionally, the wayside devices may include other devices or systems.

The images and/or video captured and output by the camera 106 can record actions performed by the operator onboard the vehicle system 100, but also may capture the wayside devices as the vehicle system 100 travels past the wayside devices. While the camera 106 may be disposed onboard and inside the vehicle system 100 in one embodiment, the camera 106 may be oriented such that the field of view 110 of the camera 106 includes the wayside devices (e.g., through one or more windows 108 of the vehicle system 100).

Optionally, the imaging system 102 can include one or more external or exterior cameras, or the camera 106 may be an external or exterior camera. An external or exterior camera is a camera that is coupled with the vehicle system 100 outside of the cab (e.g., on an exterior surface of the vehicle system 100) so that the field of view 110 of the camera 106 includes at least part of the exterior of the vehicle system 100. For example, the field of view 110 can capture portions of the route 104 and/or the wayside devices during movement of the vehicle system 100 on the route 104.

The camera 106 may be a digital camera capable of obtaining relatively high quality image data (e.g., static or still images and/or videos). For example, the camera 106 may be Internet protocol (IP) cameras that generate packetized image data. The camera 106 can be a high definition (HD) camera capable of obtaining image data at relatively high resolutions. For example, the camera 106 may obtain image data having at least 480 horizontal scan lines, at least 576 horizontal scan lines, at least 720 horizontal scan lines, at least 1080 horizontal scan lines, or an even greater resolution. The image data generated by the camera 106 can include still images and/or videos.

A controller 112 of the imaging system 102 includes or represents hardware circuits or circuitry that includes and/or is connected with one or more computer processors, such as one or more computer microprocessors. The controller 112 can dictate operational states of the camera 106, save image data obtained by the camera 106 to one or more memory devices 114 of the imaging system 102, generate alarm signals responsive to identifying one or more problems with the route 104 and/or the wayside devices based on the image data that is obtained, or the like.

The memory device 114 includes one or more computer readable media used to at least temporarily store the image data provided by the camera 106. Without limitation, the memory device 114 can include a computer hard drive, flash drive, optical disk, or the like. The memory device 114 may be disposed entirely onboard the vehicle system 100, or may be at least partially stored off-board the vehicle system 100, such as in a dispatch facility, another vehicle, or the like.

During travel of the vehicle system 100 along the route 104, the camera 106 can generate image data representative of images and/or video of the field of view 110 of the camera 106. This image data can represent actions occurring in the interior of the vehicle system 100 (e.g., the operator changing operational settings of the vehicle system 100). For example, one use for the image data may be for an accident investigation, where the actions of an onboard operator are examined to determine if the operator was present at the controls of the vehicle system 100 at the time of the accident, if the operator was awake and aware leading up to the accident, if the proper actions were taken leading up to the accident (e.g., a horn or other alarm was activated, the brakes were engaged, etc.), and the like.

Additionally or alternatively, the image data may be used to inspect the health of the route 104, status of wayside devices along the route 104 being traveled on by the vehicle system 100, or the like. As described above, the field of view 110 of the camera 106 can encompass at least some of the route 104 and/or wayside devices disposed ahead of the vehicle system 100 along a direction of travel of the vehicle system 100. During movement of the vehicle system 100 along the route 104, the camera 106 can obtain image data representative of the route 104 and/or the wayside devices for examination to determine if the route 104 and/or wayside devices are functioning properly, or have been damaged, need repair, and/or need further examination.

The image data created by the camera 106 can be referred to as machine vision, as the image data represents what is seen by the imaging system 102 in the field of view 110 of the camera 106. One or more analysis processors 116 of the imaging system 102 may examine the image data to identify conditions of the route 104 and/or wayside devices. Optionally, the analysis processor 116 can examine the terrain at, near, or surrounding the route 104 and/or wayside devices to determine if the terrain has changed such that maintenance of the route 104, wayside devices, and/or terrain is needed. For example, the analysis processor 116 can examine the image data to determine if vegetation (e.g., trees, vines, bushes, and the like) is growing over the route 104 or a wayside device (such as a signal) such that travel over the route 104 may be impeded and/or view of the wayside device may be obscured from an operator of the vehicle system 100. As another example, the analysis processor 116 can examine the image data to determine if the terrain has eroded away from, onto, or toward the route 104 and/or wayside device such that the eroded terrain is interfering with travel over the route 104, is interfering with operations of the wayside device, or poses a risk of interfering with operation of the route 104 and/or wayside device. Thus, the terrain “near” the route 104 and/or wayside device may include the terrain that is within the field of view of the camera 106 when the route 104 and/or wayside device is within the field of view of the camera 106, the terrain that encroaches onto or is disposed beneath the route 104 and/or wayside device, and/or the terrain that is within a designated distance from the route 104 and/or wayside device (e.g., two meters, five meters, ten meters, or another distance).

The analysis processor 116 can represent hardware circuits and/or circuitry that include and/or are connected with one or more computer processors, such as one or more computer microprocessors. While the analysis processor 116 is shown as being disposed onboard the vehicle system 100, optionally, all or part of the analysis processor 116 may be located off-board of the vehicle system 100, such as in a dispatch facility or other location.

Acquisition of HD image data from the camera 106 can allow for the analysis processor 116 to have access to sufficient information to examine individual video frames, individual still images, several video frames, or the like, and determine the condition of the wayside devices and/or terrain at or near the wayside device. The HD image data optionally can allow for the analysis processor 116 to have access to sufficient information to examine individual video frames, individual still images, several video frames, or the like, and determine the condition of the route 104. The condition of the route 104 can represent the health of the route 104, such as a state of damage to one or more rails of a track, the presence of foreign objects on the route, overgrowth of vegetation onto the route, and the like. As used herein, the term “damage” can include physical damage to the route (e.g., a break in the route, pitting of the route, or the like), movement of the route from a prior or designated location, growth of vegetation toward and/or onto the route, deterioration in the supporting material (e.g., ballast material) beneath the route, or the like. For example, the analysis processor 116 may examine the image data to determine if one or more rails are bent, twisted, broken, or otherwise damaged. Optionally, the analysis processor 116 can measure distances between the rails to determine if the spacing between the rails differs from a designated distance (e.g., a gauge or other measurement of the route).

In one embodiment, because the HD image data includes a sufficiently large amount of data, the analysis processor 116 may examine the image data for damage to the route 104 in real time. By “real time,” it is meant that the analysis processor 116 examines the image data to identify damage to the route 104, examine the wayside device, and/or examine nearby terrain while the vehicle system 100 is moving along the route 104. Optionally, the analysis processor 116 (and/or another off-board analysis processor 116) may perform post-hoc processing and/or analysis of the image data. “Post-hoc” refers to the examination of the image data after the vehicle system 100 has completed a trip. For example, during a trip of the vehicle system 100 from a starting location to a destination location, the camera 106 can generate image data that captures views of the route 104 and/or wayside devices. Real time examination of this image data includes examination of the image data while the vehicle system 100 is moving from the starting location to the destination location, while post-hoc examination of the image data includes examination of the image data onboard and/or off-board the vehicle system 100 after the vehicle system 100 has arrived at the destination location (and/or is no longer moving).

The analysis of the image data by the analysis processor 116 can be performed using one or more image and/or video processing algorithms, such as edge detection, pixel metrics, comparisons to benchmark images, object detection, gradient determination, or the like.

Edge detection refers to the examination of the image data to identify edges of objects in the image data, such as the edges of the rails of a track. As one example, the edges of the objects can be identified by finding the pixels in one or more frames of the image data that have the same or similar (e.g., within a designated range of each other) intensity and/or that are located adjacent or near each other (e.g., within a designated distance of each other). Those pixels having the same or similar intensity and located adjacent or near each other can be identified as representing an object. The pixels on the outer edges of the object can be differentiated from other pixels that are outside of the object based on differences between the pixel intensities. For example, the differences in intensities between pixels within the object may be smaller than the differences in intensities between a pixel on the outer edge of the object and a pixel outside of the object (and/or that is adjacent to or near the outer edge of the object). Based on these differences, the analysis processor 116 can identify the edges of the object.

Pixel metrics can refer to one or more algorithms that measure qualities of the pixels to identify objects in the image data. While pixel intensities are described above, optionally, pixel metrics can include measuring color, luminance, or another parameter of the pixels in the image data. The pixel metrics can be compared or otherwise examined in order to determine locations of objects (e.g., rails) in the image data for identifying damage to the route 104.

The use of benchmark images includes the analysis processor 116 comparing actual image data to one or more benchmark images to determine if any differences (e.g., significant differences other than noise) between the actual and benchmark images are present. The benchmark images can include previously acquired image data of a wayside device and/or nearby terrain. The previously acquired image data may be obtained at a time when the wayside device and/or nearby terrain was known to be in good or at least acceptable condition. Optionally, the benchmark image may be an image or video that is created (e.g., not an actual image) to represent the shape or other appearance of the wayside device and/or nearby terrain. The created benchmark image may be designed to represent the wayside device and/or nearby terrain when the wayside device and/or nearby terrain are in good or at least acceptable condition.

The analysis processor 116 can compare the actual image data with the benchmark image data if the shape, size, arrangement, color, or the like, of objects, edges, pixels, or the like, identified the actual image data are the same as or within a designated range of each other. For example, the analysis processor 116 can identify edges of objects in the actual image data (e.g., using edge detection algorithms described above or in another manner). These edges can be used to estimate the shape, location, and/or arrangement of objects in the actual image data. Some of these objects can represent the wayside devices and/or the terrain nearby. The identified objects in the actual image data can be compared with the known shape, location, and/or arrangement of objects in the benchmark image data. Depending on the amount of spatial overlap and/or the lack of spatial overlap between the object(s) in the actual image data and the object(s) in the benchmark image data, the analysis processor 116 may determine that the wayside device is or is not in the proper position, has or has not been damaged, and the like. For example, if the object(s) in the actual image data match or are relatively close to matching the object(s) in the benchmark image data, then the analysis processor 116 can determine that the wayside device and/or nearby terrain is in acceptable condition. Otherwise, the analysis processor 116 can determine that the wayside device and/or nearby terrain is damaged, has moved, or otherwise is in an unacceptable position.

The analysis processor 116 can examine one or more parameters of the pixels, such as the intensities, color, luminance, or the like, of the pixels in one or more areas of the actual image data from the camera 106 to determine gradients of these pixel parameters. The gradients can represent a degree or rate at which these parameters change over a designated area, such as across a frame of the image data or another area or distance. The analysis processor 116 can compare the determined gradients to one or more designated gradients that are associated with image data representative of the wayside device and/or nearby terrain that is in acceptable condition (e.g., not damaged, overgrown, eroded, or the like). If the determined gradients differ from the designated gradients, then the analysis processor 116 can determine that the image data does not include the wayside device, or that the wayside device and/or nearby terrain is damaged or otherwise in unacceptable condition.

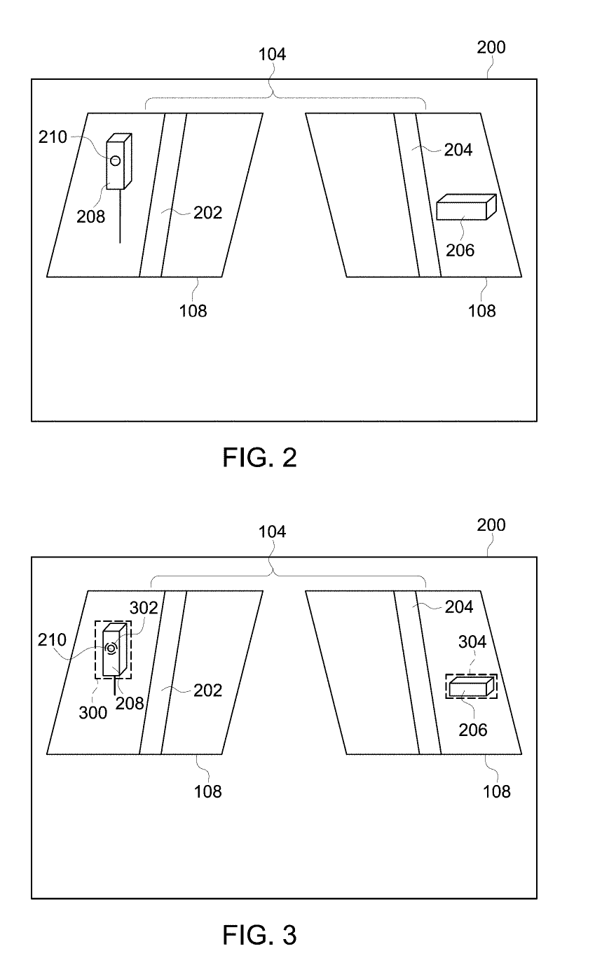

With continued reference to the imaging system 102 shown in FIG. 1, FIG. 2 illustrates an image 200 representative of image data generated by the camera 106 for examination by the analysis processor 116 according to one embodiment. The image 200 illustrates portions of rails 202, 204 of the route 104 as viewed from the interior camera 106 through the windows 108 of the vehicle system 100. Also viewable in the image 200 alongside the route 104 is an inspection wayside device 206 and a signaling wayside device 208. The inspection wayside device 206 may inspect one or more components of the vehicle system 100 as the vehicle system 100 moves past the inspection wayside device 206. For example, the inspection wayside device 206 may include an infrared detector, or “hot box detector,” or other inspection device. The signaling wayside device 208 is shown as a light signal that changes color to indicate a status of an upcoming segment of the route 104 and/or a speed that the vehicle system 100 should use, such as by illuminating one or more lights with a green, yellow, or red color. While only one light 210 is shown in the signaling wayside device 208, optionally, the signaling wayside device 208 may include multiple lights or may signal the vehicle system 100 in another manner.

As described above, the analysis processor 116 can examine the image data to identify objects (e.g., shapes) in the image data. These shapes may correspond to the wayside devices 206, 208 and/or terrain near the wayside devices 206, 208. The shapes of these objects can be identified using pixel metrics, edge detection, pixel gradients, comparisons to benchmark images, object detection, or the like.

The analysis processor 116 can compare the actual image data shown in FIG. 2 with benchmark image data that represents locations of where objects representative of the wayside devices 206, 208 and/or nearby terrain are to be located. In order to determine which benchmark image data to compare to the actual image data, the analysis processor 116 can determine the location of the vehicle system 100 and select at least one set of benchmark image data from several sets of benchmark image data (e.g., stored on the memory device 114 or otherwise accessible by the analysis processor 116). The different sets of benchmark image data can be representative of the wayside devices at different locations along the route 104. Once the analysis processor 116 identifies the location of the vehicle system 100 when the image data shown in the image 200 was obtained, the analysis processor 116 can obtain the benchmark image data representative of the wayside devices and/or nearby terrain associated with that location.

In order to determine the locations of the vehicle system 100, the imaging system 102 can include or be coupled with a location determining device 118 that generates location data representative of where the vehicle system 100 is located. The location determining device 118 can represent a global positioning system (GPS) receiver, a radio frequency identification (RFID) transponder that communicates with RFID tags or beacons disposed alongside the route 104, a computer that triangulates the location of the vehicle system 100 using wireless signals communicated with cellular towers or other wireless signals, a speed sensor (that outputs data representative of speed, which is translated into a distance from a known or entered location by the controller 112), or the like. The location determining device 118 can include an antenna 120 (and associated hardware receiver or transceiver circuitry) for determining the location data. The analysis processor 116 can receive this data and can determine the location of the vehicle system 100.

The location data can be associated with the image data in order to indicate where the portion of the route 104 that is shown in the image data is located. For example, the location data can be included in the image data as metadata or other data that is saved with the image data. Optionally, the location data may be stored separately from the image data but associated with the image data, such as in a table, list, database, or other memory structure. The location and/or time information can be shown on the image 200, such as by overlaying this information on the image. The location and/or time information can represent the location where the image data that is shown in the image 200 was acquired and/or when this image data was acquired. For example, the location and/or time information can indicate the GPS coordinates of the segment of the route 104 that is shown in the image 200.

In one embodiment, the location data may be used to control when the camera 106 obtains image data and/or which image data is examined by the analysis processor 116. For example, different areas, or zones, may be identified as including wayside devices to be examined using the image data acquired and output by the camera 106. Responsive to the vehicle system 100 entering into such a zone based on the location data, the camera 106 may begin obtaining and/or sending image data to the analysis processor 116, and/or the analysis processor 116 may begin examining the image data. Upon exit from the zone, the camera 106 may stop obtaining and/or sending the image data to the analysis processor 116, and/or the analysis processor 116 may stop examining the image data. Alternatively, the analysis processor 116 may only examine the image data that is acquired by the camera 106 when the vehicle system 100 is inside such a zone.

The analysis processor 116 examines the image data to identify problems with the route 104. In one aspect, the analysis processor 116 compares locations and/or arrangements of the route 104 in the image data with designated locations and/or arrangements of the route 104, such as which can be stored in the memory device 114.

FIG. 3 illustrates one example of a comparison between the image data acquired by and output from the camera 106 with baseline image data according to one embodiment. The baseline image data represents how the wayside devices 206, 208 and/or surrounding terrain is expected to appear in the image data output by the camera 106 if the wayside devices 206, 208 are in acceptable condition (e.g., have not been moved, vandalized or otherwise damaged, are not overgrown with vegetation, are not covered due to erosion, or the like).

The baseline image data includes baseline objects 300, 302, 304 shown in dashed lines in FIG. 3. These objects 300, 302, 304 represent where the wayside devices 206, 208 are expected to be when the vehicle system 100 is at or near a designated location associated with the baseline objects 300, 302, 304 and the wayside devices 206, 208 and/or nearby terrain are in acceptable condition. The baseline objects 300, 302, 304 may change location, size, arrangement, or the like, for image data acquired when the vehicle system 100 is in another location.

The analysis processor 116 can determine the locations of the objects representative of the wayside devices 206, 208 (e.g., the signal, the light, the inspection device, or the like) from the actual image data that is output by the camera 106 and compare this to the baseline objects of the baseline image data. The comparison can involve determining if the actual objects (e.g., representative of the wayside devices 206, 208) are in the same or overlapping locations as the baseline objects in the image data or image 200. In the illustrated example, the analysis processor 116 can determine that the object representative of the wayside device 206 is in the same location as the baseline object 304 or overlaps the area encompassed by the baseline object 304 for a least a designated fraction of the baseline object 304. If the actual imaged object and the baseline object overlap by at least this designated fraction, then the analysis processor 116 can determine that the wayside device 206, 208 is in acceptable condition. Otherwise, the analysis processor 116 may determine that the wayside device 206, 208 and/or terrain is in an unacceptable condition.

The designated fraction may be a percentage such as 50%, 60%, 70%, 80%, 90%, or another amount, depending on how sensitive the analysis processor 116 is to be in identifying problems with the wayside devices 206, 208 and/or nearby terrain. For example, lowering the designated fraction may cause the analysis processor 116 to identify more problems with the wayside devices 206, 208 and/or terrain, but also may cause the analysis processor 116 to falsely identify such problems when no problems actually exist. Increasing the designated fraction may cause the analysis processor 116 to identify fewer problems with the wayside devices 206, 208 and/or terrain, but also may cause the analysis processor 116 to miss some identification of some problems.

Based on the large amount of overlap between the signal wayside device 208 and the baseline object 300, between the light 210 and the baseline object 302, and/or between the inspection wayside device 206 and the baseline object 304, the analysis processor 116 can determine that the wayside devices 206, 208 and/or the terrain are in acceptable condition.

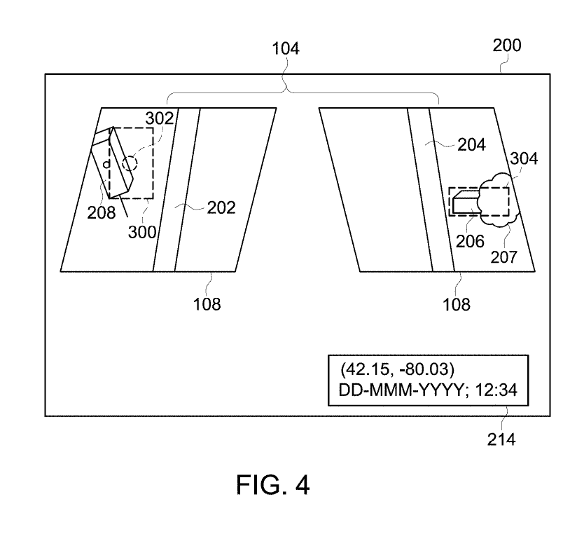

FIG. 4 illustrates another example of a comparison between the image data acquired by and output from the camera 106 with baseline image data according to one embodiment. In contrast to the image data shown in FIG. 3, the image data shown in FIG. 4 includes a foreign object 207 at least partially obstructing the view of the inspection wayside device 206 and the signaling wayside device 208 being damaged (e.g., bent out of position and the light 210 shown in FIGS. 2 and 3 being removed or damaged). The foreign object 207 can represent growth of vegetation on or around the wayside device 206, erosion of the terrain onto or around the wayside device 206, or another object disposed on or near the wayside device 206. The presence of the foreign object 207 may interfere with functions of the wayside device 206. Similarly, the damage to the wayside device 208 may interfere with signaling functions of the wayside device 208.

The analysis processor 116 can compare the actual objects in the image data representative of the wayside devices 206, 208 with the baseline objects 300, 302, 304 to determine if the actual objects match the baseline objects. For example, the analysis processor 116 can calculate the amount of overlap between the actual objects and the baseline objects 300, 302, 304. With respect to the wayside device 208 and the baseline object 300, very little overlap exists. With respect to the light 210 and the baseline object 302, the damage or removal of the light 210 may prevent the analysis processor 116 from identifying any object where the light 210 should be located. With respect to the wayside device 206 and the baseline object 304, the object 207 (e.g., eroded terrain, vegetation, other foreign objects, or the like) is partially blocking the view of the wayside device 206.

The analysis processor 116 can determine that the object 207 is not part of the wayside device 206 based on edge detection between the object 207 and the wayside device 206, differences in pixel metrics between the object 207 and the wayside device 206, or the like. The presence of the object 207 prevents the analysis processor 116 from identifying the wayside device 206 as being in acceptable condition because not enough of the wayside device 206 overlaps the baseline object 304. For example, because the fraction of the baseline object 304 that is overlapped by the wayside device 206 does not exceed a designated amount, the analysis processor 116 may determine that the wayside device 206 is not in a location where the wayside device 206 was installed, that the wayside device 206 has become damaged or stolen, that the terrain is occluding the view of the wayside device 206, or the like.

Responsive to identifying the unacceptable conditions of the wayside devices 206, 208, the analysis processor 116 may flag or otherwise mark the image data that represents the damage. By “flag” or “mark,” it is meant that the portion or subset of the image data that includes the damaged section of the route 104 can be saved to the memory device 114 with additional data (e.g., metadata or other information) that indicates which portion of the image data represents these wayside devices 206, 208. Optionally, the analysis processor 116 may save data representative of which portion of the image data shows these wayside devices 206, 208 in another location (e.g., separate from the image data).

In the illustrated example, the image 200 generated from the image data includes location and/or time information 214 that is shown on the image. The location and/or time information 214 can represent the location where the image data that is shown in the image 200 was acquired and/or when this image data was acquired. For example, the location and/or time information 214 can indicate the GPS coordinates of the wayside devices 206, 208 that are shown in the image 200. This information can be overlaid on the image 200 to assist viewers of the image 200 in determining where and/or when the wayside devices 206, 208 were identified as being damaged or otherwise in unacceptable condition.

The analysis processor 116 can generate one or more reporting signals responsive to identifying the unacceptable conditions of the wayside devices 206, 208. The reporting signals can include the portions of the image data that show the wayside devices 206, 208. For example, the reporting signals can include an edited version of the image data, with the portions of the image data that show the wayside devices 206, 208 included and other portions of the image data that do not show the wayside devices 206, 208 not included.

The reporting signals with the included edited image data can be locally saved onto the memory device 114 onboard the vehicle system 100 and/or communicated to an off-board location having a memory device 114 for storing the edited image data. As described above, location data may be included in the image data such that the location data is included in the edited image data.

In one aspect, the analysis processor 116 may examine image data of the wayside devices obtained at different times to determine if the conditions of the wayside devices are changing over time. For example, the analysis processor 116 can compare image data of the same location of the route 104 obtained at different times over the course of several days, weeks, months, or years. Based on this comparison and changes in the wayside devices, the analysis processor 116 can determine that the condition of the wayside devices is exhibiting a downward or negative trend.

The analysis processor 116 can compile the image data of the same section of the route 104 obtained at different times into compilation image data. This compilation image data (and/or other image data described herein) can be presented to an operator of the imaging system 102, such as on a display device 122. The display device 122 may be a monitor, television, touchscreen, or other output device that visually presents image data. The display device 122 can be disposed onboard the vehicle system 100 and/or at an off-board facility, such as a dispatch center or elsewhere. The operator can examine the compilation image data to identify the changes in the route 104 over time. Optionally, the analysis processor 116 may use one or more software algorithms, such as edge detection, pixel metrics, or the like, to identify objects in the compilation image data. The analysis processor 116 can then automatically identify changes or trends in the condition of the wayside devices using the compilation image data.

In one embodiment, the memory device 114 and/or the analysis processor 116 may receive image data of the same wayside devices obtained by different vehicle systems 100. For example, as separate vehicle systems 100 that are not traveling together travel over the same segment of the route 104 obtain image data of the wayside devices at different times, the image data can be sent to the analysis processor 116 and/or memory device 114. The analysis processor 116 and/or memory device 114 can be disposed onboard of off-board the vehicle system 100. The analysis processor 116 can examine this image data of the same wayside devices from diverse sources (e.g., the imaging systems 102 on different vehicle systems 100) to identify damage to the wayside devices and/or trends in the condition of the wayside devices.

A communication system 124 of the imaging system 102 represents hardware circuits or circuitry that include and/or are connected with one or more computer processors (e.g., microprocessors) and communication devices (e.g., wireless antenna 126 and/or wired connections 128) that operate as transmitters and/or transceivers for communicating signals with one or more locations disposed off-board the vehicle system 100. For example the communication system 124 may wirelessly communicate signals (e.g., image data) via the antenna 126 and/or communicate the signals over the wired connection 128 (e.g., a cable, bus, or wire such as a multiple unit cable, train line, or the like) to a facility and/or another vehicle system, or the like.

In one embodiment, the imaging system 102 is disposed onboard a vehicle system 100 that propels cargo. For example, instead of the imaging system 102 being disposed onboard a specially outfitted vehicle (e.g., a vehicle designed for the sole purpose of inspecting the route), the imaging system 102 may be disposed onboard a vehicle system that is designed to propel cargo so that the imaging system 102 can inspect the wayside devices 206, 208 at the same time that the vehicle system 100 is moving cargo (e.g., goods such as commodities, commercial products, or the like). The imaging system 102 may automatically obtain and/or examine image data during travel of the vehicle system 102 during other operations of the vehicle system 100 (e.g., moving freight) and, as a result, anomalies (e.g., damage) to the wayside devices 206, 208 can be identified on a repeated basis. As the vehicle system 100 travels and the imaging system 102 discovers problems with the wayside devices 206, 208, the communication system 124 may communicate (e.g., transmit and/or broadcast) alarm signals to notify others of the damage to the wayside devices 206, 208, trends in the conditions of the wayside devices 206, 208, or the like, to one or more off-board locations. For example, upon identifying a problem with one or more of the wayside devices 206, 208, the imaging system 102 can cause the communication system 124 to send an alarm signal to a repair facility so that one or more maintenance crews of workers can be sent to the location of the wayside devices 206, 208 for further inspection of the wayside devices 206, 208 and/or repair to the wayside devices 206, 208.

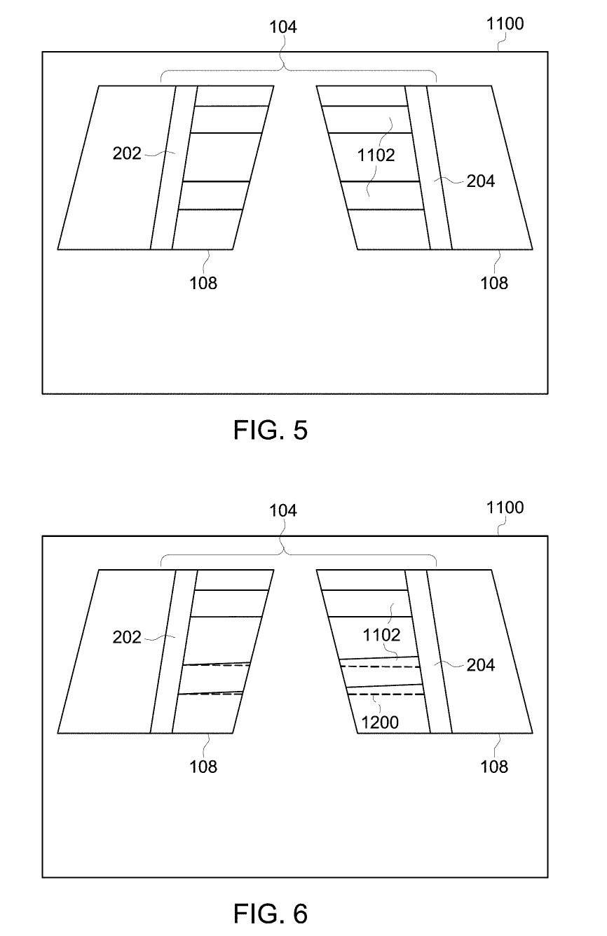

FIG. 5 illustrates an image 1100 representative of additional image data generated by the camera 106 for examination by the analysis processor 116 according to one embodiment. The image 1100 illustrates portions of the rails 202, 204 of the route 104 as viewed from the interior camera 106 through the windows 108 of the vehicle system 100. Also viewable in the image 1100 between the rails 202, 204 are supporting bodies 1102. The supporting bodies 1102 can represent ties, such as railroad ties, railway ties, crossties, railway sleepers, or other bodies that support the rails 202, 204 and/or assist in keeping the rails 202, 204 parallel to each other. As described above, the analysis processor 116 can examine the image data to identify objects (e.g., shapes) in the image data. These shapes may correspond to the supporting bodies 1102. The shapes of these objects can be identified using pixel metrics, edge detection, pixel gradients, comparisons to benchmark images, object detection, or the like. The analysis processor 116 examines the image data to identify problems with the route 104. In one aspect, the analysis processor 116 compares locations and/or arrangements of the route 104 in the image data with designated locations and/or arrangements of the route 104, such as which can be stored in the memory device 114.

FIG. 6 illustrates one example of a comparison between the image data acquired by and output from the camera 106 with baseline image data according to one embodiment. The baseline image data represents how the supporting bodies 1102 are expected to appear in the image data output by the camera 106 if the supporting bodies 1102 are in acceptable condition (e.g., have not been moved or otherwise damaged). The baseline image data includes baseline objects 1200 shown in dashed lines in FIG. 6. These objects 1200 represent where the supporting bodies 1102 are expected to be when the vehicle system 100 is at or near a designated location associated with the baseline objects 1200 and the supporting bodies 1102. The baseline objects 300, 302, 304 may change location, size, arrangement, or the like, for image data acquired when the vehicle system 100 is in another location.

The analysis processor 116 can determine the locations of the objects representative of the supporting bodies 1102 from the actual image data that is output by the camera 106 and compare this to the baseline objects of the baseline image data. The comparison can involve determining if the actual objects are in the same or overlapping locations as the baseline objects in the image data or image 1100. In the illustrated example, the analysis processor 116 can determine that one of the objects representative of one of the supporting bodies 1102 is in the same location as one of the baseline objects 1200 or overlaps the area encompassed by the baseline object 1200 for a least a designated fraction of the baseline object 1200. As a result, the outer boundaries of the baseline object 1200 are not visible outside of or inside of the object representative of one of the supporting bodies 1102.

But, another object representative of a supporting body 1102 in the image data 1100 appears to be angled with respect to another baseline object 1200. The analysis processor 116 can compare the edges of the supporting body 1102 with the baseline object 1200, the overlap (or lack of overlap) between the areas in the image data 1100 that are encompassed by the supporting body 1102 and the baseline object 1200, or the like, to determine if the supporting body 1102 is out of position. In the illustrated example, the analysis processor 116 may determine that the supporting body 1102 has shifted or otherwise moved out of position due to the area encompassed by the supporting body 1102 only overlapping the area encompassed by the baseline object 1200 by less than a designated threshold amount.

As described above, responsive to determining that the supporting body 1102 is out of position, the analysis processor 116 may flag or otherwise mark the image data 1100. The image data 1100 may be saved with or otherwise associated with time and/or location data to assist in later determining where the out-of-position supporting body 1102 is located. The analysis processor 116 can generate one or more reporting signals responsive to identifying the unacceptable condition of the supporting body 1102, similar to as described above.

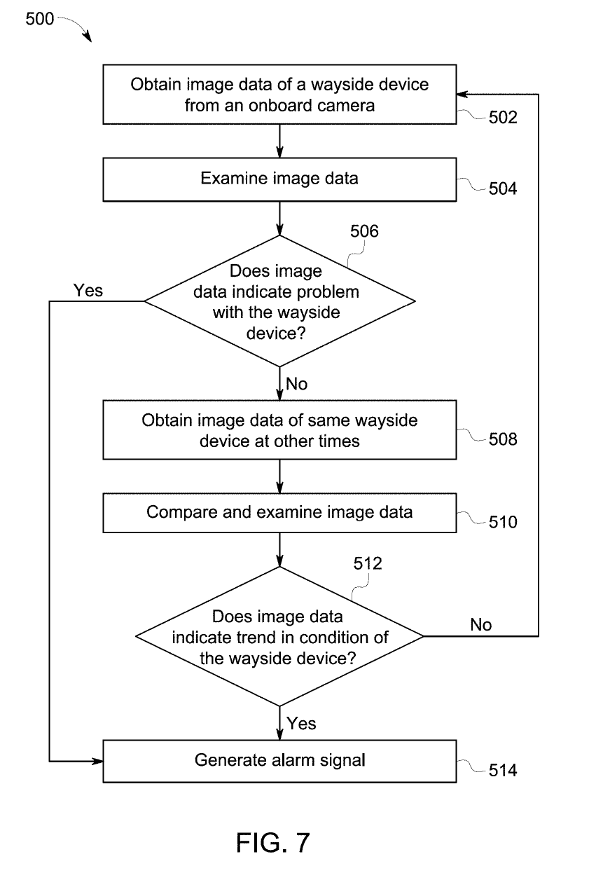

FIG. 7 illustrates a flowchart of a method 500 for imaging one or more wayside devices disposed along a route traveled by one or more vehicle systems according to one embodiment. The method 500 may be used to obtain image data of the wayside devices to determine if one or more problems exist with the wayside devices, such as damage to the wayside devices, a deteriorating condition of the wayside devices, or the like. At least one embodiment of the method 500 may be practiced using the imaging system 102 (shown in FIG. 1) described herein.

At 502, image data of one or more wayside devices are obtained from a camera onboard a vehicle system. For example, a camera that is positioned to obtain video of an operator disposed on the vehicle system also may obtain video of wayside devices disposed outside the vehicle system along a route being traveled by the vehicle system. This camera may be installed to monitor actions (or lack thereof) of an operator for liability or other purposes (e.g., such as in post-accident investigations or reconstructions), but that also may obtain video of the wayside devices, such as through windows of the vehicle system.

At 504, the image data is examined. As described above, the image data can be examined in real time and/or after travel of the vehicle system is complete. The image data can be examined to identify locations and/or arrangements of the wayside devices. At 506, a determination is made as to whether the image data indicates a problem with the wayside devices. For example, the image data can be examined to determine if the wayside devices are damaged, vandalized, stolen, or the like, and/or if other objects are on or near the wayside devices such that the objects could prevent the wayside devices from performing one or more functions.

If the image data indicates a problem with the wayside devices, then one or more corrective actions may need to be taken. As a result, flow of the method 500 can proceed to 514. On the other hand, if the image data does not indicate such a problem, then additional image data (e.g., previously and/or subsequently acquired image data of the same wayside devices) may be examined to determine if the conditions of the wayside devices are deteriorating, if foreign objects (e.g., vegetation) are moving toward the wayside devices, or the like. As a result, flow of the method 500 can proceed to 508. Alternatively, no further analysis is performed on this or other image data, and the method 500 can terminate.

At 508, additional image data of the same wayside devices can be obtained. This additional image data may be generated by one or more cameras at different times than when the image data is obtained at 502. For example, the additional image data can be generated by cameras of imaging systems on other vehicle systems on prior days, weeks, months, or years, and/or subsequent days, weeks, months, or years.

At 510, the image data and additional image data are compared with each other and examined. The image data and additional image data are compared and examined in order to determine if the image data and additional image data exhibit changes in the wayside devices over time. For example, while a single or multiple set of the image data acquired at one or more times may not indicate damage to the wayside devices due to the damage being relatively minor, examining more image data acquired over longer periods of time may illustrate a change and/or damage to the wayside devices more than a smaller amount of image data and/or image data obtained over shorter time periods.

At 512, a determination is made as to whether the image data and the additional image data indicate a trend in the condition of the one or more wayside devices. For example, the image data and additional image data can be examined to determine if the wayside device are gradually becoming more damaged, if the wayside device is gradually changing location, if vegetation is growing toward and/or onto the wayside device, if the ground near the wayside device is eroding or building up onto the wayside device, or the like. Alternatively, the image data acquired at different times can be examined to identify damage to the wayside device without identifying a trend in the condition of the route.

If the image data and additional image data indicate a problem with the wayside device, then one or more corrective actions may need to be taken. As a result, flow of the method 500 can proceed to 514. On the other hand, if the image data and the additional image data do not indicate such a problem, then flow of the method 500 may return to 502 so that additional image data of the same or other wayside devices may be obtained. Alternatively, no further analysis is performed on this or other image data, and the method 500 can terminate.

At 514, one or more alarm signals are generated. The alarm signals may be communicated from the analysis processor (which is onboard and/or off-board a vehicle system) to an off-board facility to request further inspection of the wayside device and/or repair to the wayside device. Optionally, an alarm signal may be communicated to one or more vehicle systems to warn the vehicle systems of the identified problem with the wayside device. In one aspect, the alarm signal can be communicated to a scheduling system that generates schedules for vehicle systems so that the scheduling system can alter the schedules of the vehicle systems to avoid and/or slow down over the section of the route where the wayside device identified as having the problem is located.

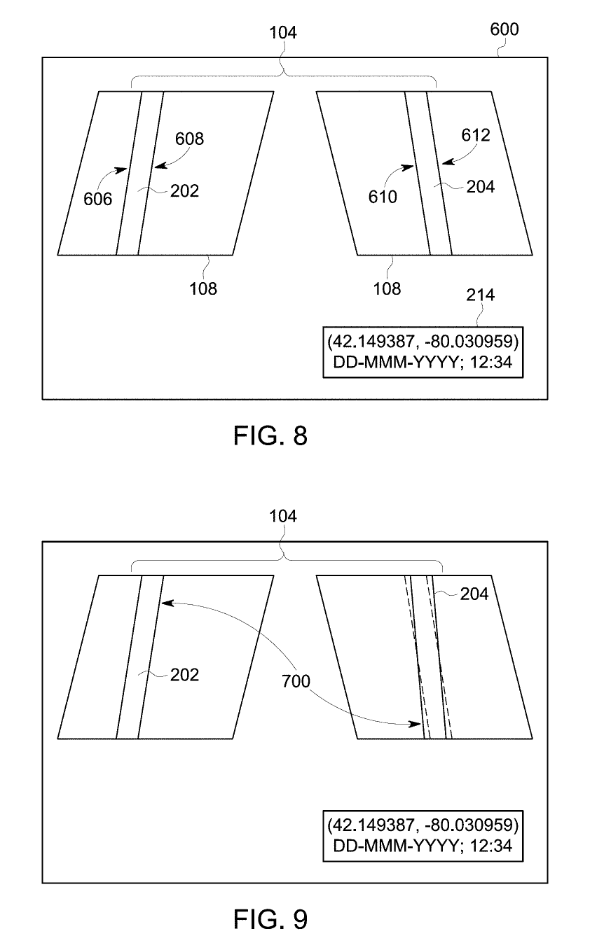

FIG. 8 illustrates another image 600 representative of image data generated by the camera 106 for examination by the analysis processor 116 according to one embodiment. The image 600 illustrates portions of the rails 202, 204 of the route 104 as viewed from the interior camera 106 through the windows 108 of the vehicle system 100. As described above, the analysis processor 116 can examine the image data to identify edges 606, 608, 610, 612 of the rails 202, 204. These edges can be used to determine locations of the rails 202, 204 in the image 200.

As described above, location data can be associated with the image data in order to indicate where the portion of the route 104 that is shown in the image data is located. For example, the location data can be included in the image data as metadata or other data that is saved with the image data. Optionally, the location data may be stored separately from the image data but associated with the image data, such as in a table, list, database, or other memory structure. In the illustrated example, the image 200 generated from the image data includes the location and/or time information 214 that is shown on the image.

The analysis processor 116 examines the image data to identify problems with the route 104. In one aspect, the analysis processor 116 compares locations and/or arrangements of the route 104 in the image data with designated locations and/or arrangements of the route 104, such as which can be stored in the memory device 114.

FIG. 9 illustrates one example of a comparison between the route 104 as represented by the image data generated by the camera 106 with a baseline route image 700 according to one embodiment. The baseline route image 700 represents how the route 104 (e.g., the rails 202, 204 of the route 104) is to appear in the image data if the route 104 is not damaged. For example, the baseline route image 700 can represent locations of the route 104 prior to the route 104 being damaged or degrading.

The baseline route image 700 using dashed lines while locations of the rails 202, 204 are shown using solid lines in FIG. 8. With respect to the rail 202, the location of the rail 202 in the image data exactly or closely matches or otherwise corresponds to the designated location of the rail 202 that is represented by the baseline route image 700 (e.g., the location of the rail 202 is within a designated range of distances, pixels, or the like). As a result, the dashed lines of the baseline route image 700 that correspond to the rail 202 are not visible due to the solid lines of the actual rail 202 in the image data.

With respect to the rail 204, however, the location of the rail 204 in the image data does not exactly or closely match the designated location of the rail 204 in the baseline route image 700. As a result, the baseline route image 700 and the rail 204 do not exactly or closely overlap in the image data.

In one example, the analysis processor 116 can identify this mismatch between the baseline route image 700 and the image data and determine that one or more of the rails 202, 204 have become damaged, such as by being bent, twisted, broken, or otherwise damaged. Optionally, the analysis processor 116 can measure distances between the rails 202, 204 in the image data and compare these distances to one or more designated distances representative of the gauge of the route 104. If the measured distances differ from the designated distances by more than a threshold amount, then the analysis processor 116 determines that the route 104 is damaged at or near the location where the image data was obtained (as determined from the location data).

Responsive to identifying the damage to the route 104, the analysis processor 116 may flag or otherwise mark the image data that represents the damage. By “flag” or “mark,” it is meant that the portion or subset of the image data that includes the damaged section of the route 104 can be saved to the memory device 114 with additional data (e.g., metadata or other information) that indicates which portion of the image data represents the damaged section of the route 104. Optionally, the analysis processor 116 may save data representative of which portion of the image data includes the damaged portion of the route 104 in another location (e.g., separate from the image data).

The analysis processor 116 can generate one or more reporting signals responsive to identifying one or more damaged sections of the route 104. The reporting signals can include the portions of the image data that show the damaged sections. For example, the reporting signals can include an edited version of the image data, with the portions of the image data that show the damaged sections of the route included and other portions of the image data that do not show the damaged sections not included.

The reporting signals with the included edited image data can be locally saved onto the memory device 114 onboard the vehicle system 100 and/or communicated to an off-board location having a memory device 114 for storing the edited image data. As described above, location data may be included in the image data such that the location data is included in the edited image data.

In one aspect, the analysis processor 116 may examine image data of the same route 104 obtained at different times to determine if the health of the route 104 is changing over time. For example, the analysis processor 116 can compare image data of the same location of the route 104 obtained at different times over the course of several days, weeks, months, or years. Based on this comparison and changes in the shape, location, arrangement, and the like, of the rails of the route 104, other objects near the route 104 (e.g., vegetation, ballast material, erosion or movement of hills near the route 104, etc.), and the like, the analysis processor 116 can determine that the health of the route 104 at that location is exhibiting a downward or negative trend. For example, the location of one or more rails may gradually change, the vegetation and/or hillside may gradually move toward and/or encroach onto the rails, the amount of ballast material may gradually change, or the like.

The analysis processor 116 can compile the image data of the same section of the route 104 obtained at different times into compilation image data. This compilation image data (and/or other image data described herein) can be presented to an operator of the imaging system 102, such as on the display device 122. The operator can examine the compilation image data to identify the changes in the route 104 over time. Optionally, the analysis processor 116 may use one or more software algorithms, such as edge detection, pixel metrics, or the like, to identify objects in the compilation image data. The analysis processor 116 can then automatically identify changes or trends in the health of the route 104 using the compilation image data.

In one embodiment, the memory device 114 and/or the analysis processor 116 may receive image data of the same section of the route 104 obtained by different vehicle systems 100. For example, as separate vehicle systems 100 that are not traveling together travel over the same segment of the route 104 obtain image data of the route 104 at different times, the image data can be sent to the analysis processor 116 and/or memory device 114. The analysis processor 116 and/or memory device 114 can be disposed onboard of off-board the vehicle system 100. The analysis processor 116 can examine this image data of the same segment of the route 104 from diverse sources (e.g., the imaging systems 102 on different vehicle systems 100) to identify damage to the route and/or trends in the health of the route 104.

In one embodiment, the imaging system 102 is disposed onboard a vehicle system 100 that propels cargo. For example, instead of the imaging system 102 being disposed onboard a specially outfitted vehicle (e.g., a vehicle designed for the sole purpose of inspecting the route), the imaging system 102 may be disposed onboard a vehicle system that is designed to propel cargo so that the imaging system 102 can inspect the route 104 at the same time that the vehicle system 100 is moving cargo (e.g., goods such as commodities, commercial products, or the like). The imaging system 102 may automatically obtain and/or examine image data during travel of the vehicle system 102 during other operations of the vehicle system 100 (e.g., moving freight) and, as a result, anomalies (e.g., damage) to the route 104 can be identified on a repeated basis. As the vehicle system 100 travels and the imaging system 102 discovers problems with the route 104, the communication system 124 may communicate (e.g., transmit and/or broadcast) alarm signals to notify others of the damage to the route 104, trend in health of the route 104, or the like, to one or more off-board locations. For example, upon identifying a problem with the route 104, the imaging system 102 can cause the communication system 124 to send an alarm signal to a repair facility so that one or more maintenance crews of workers can be sent to the location of the problem for further inspection of the route 104 and/or repair to the route 104.

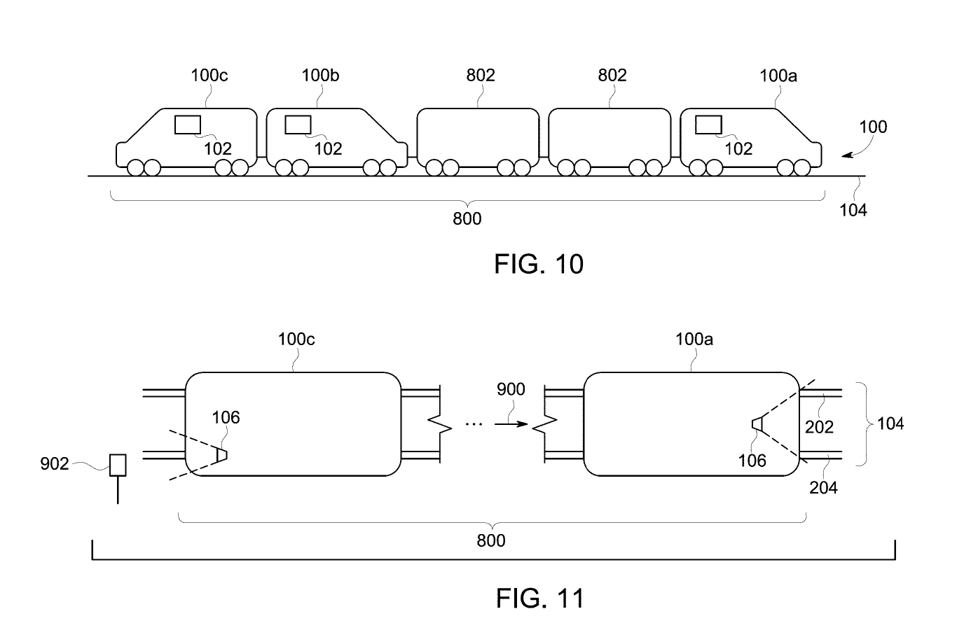

FIG. 10 illustrates a schematic diagram of a vehicle consist 800 having one or more imaging systems 102 in accordance with one embodiment. The vehicle consist 800 can include two or more vehicle systems 100 (e.g., vehicle systems 100a-c) mechanically connected with each other directly or by one or more other vehicles 802 (e.g., non-propulsion generating vehicles such as rail cars, or other propulsion-generating vehicle systems). The vehicle systems 100 and/or the cameras 106 (shown in FIG. 1) of the imaging systems 102 may be oriented in different directions. For example, the cameras 106 onboard the vehicle systems 100a, 100b may be oriented along a direction of movement of the vehicle consist 800, while the camera 106 onboard the vehicle system 100c may be oriented in an opposite direction (e.g., rearward). The vehicle systems 100 may have separate imaging systems 102, or a single imaging system 102 may span across multiple vehicle systems 100. For example, an imaging system 102 may include a controller 112 (shown in FIG. 1) that controls multiple cameras 106 onboard different vehicle systems 100 in the consist 800 and/or an analysis processor 116 (shown in FIG. 1) that examines image data obtained from multiple cameras 106 disposed onboard different vehicle systems 100 in the consist 800.

The imaging systems 102 onboard the different vehicle systems 100 in the same vehicle consist 800 can coordinate operation of the cameras 106 onboard the different vehicle systems 100. For example, a first vehicle system 100a can relay information to a second vehicle system 100b or 100c in the same vehicle consist 800. The imaging system 102 of the first vehicle system 100a may identify a segment of the route 104 and/or a wayside device that may be damaged (as described above). Responsive to this identification, the controller 112 and/or the analysis processor 116 can instruct another camera 106 onboard the same or a different vehicle system 100 of the consist 800 to change one or more operational settings and obtain additional image data. This additional image data may then be examined to confirm or refute identification of damage to the route and/or wayside device.

The operational settings that may be changed can include the focus, position, resolution, or the like, of the camera 106 onboard the second vehicle system 100. For example, responsive to image data acquired by a first camera 106 onboard the vehicle system 100a indicating that the route and/or wayside device is potentially damaged, the controller 112 and/or analysis processor 116 can send a signal to one or more additional cameras 106 disposed onboard the vehicle system 100b and/or 100c. This signal can instruct the additional camera(s) 106 to change focus (e.g., to increase or decrease the focal distance or point of the cameras 106) to obtain clearer image data of the potentially damaged route segment and/or wayside device. The signal optionally can direct the additional camera(s) 106 to change position (e.g., to change tilt, rotation, pitch, yaw, or the like) so that the image data of the additional camera(s) 106 encompasses the potentially damaged route segment and/or wayside device. The signal may instruct the additional camera(s) 106 to change resolution (e.g., a number of pixels per unit area) so that more image data of the potentially damaged route segment and/or wayside device is obtained.

The controller 112 and/or analysis processor 116 may send information to cause the camera 106 of the second vehicle system 100 to obtain image data of one or more locations of interest that may include the potentially damaged route and/or wayside device. For example, if a first locomotive goes over a piece of track, and the image data obtained by the first locomotive identifies an area of the track and/or wayside equipment that may be need of repair or further inspection, then information could be relayed to a second locomotive (for instance to the rear distributed power unit at the rear of the train) to focus in on that particular rail or location, and even change the resolution to get a better image data of the issue. Optionally, the information can be relayed between different vehicle consists that are not connected with each other. For example, responsive to identifying a damaged route and/or wayside device, the controller 112 and/or analysis processor 116 of an imaging system 102 onboard one vehicle consist 800 can direct the communication system 124 (shown in FIG. 1) to transmit and/or broadcast an assistance signal to one or more other vehicle consists 800. This signal can request the other vehicle consists 800 obtain image data of the damaged route and/or wayside device so that the damage can be confirmed, refuted, further characterized, or the like.

FIG. 11 illustrates a top view of the vehicle consist 800 shown in FIG. 10 according to one embodiment. Only the vehicle system 100a and the vehicle system 100c are shown in FIG. 11. The imaging system 102 may determine an orientation of the field of view 110 of one or more cameras 106. For example, the imaging system 102 may be able to automatically determine if the field of view 110 of a camera 106 is oriented forward or backward relative to a direction of travel 900 of the consist 800. This could help identify trouble areas of the tracks, and also just be another way to determine direction as opposed to a hard switch.

As one example, the imaging system 102 can use a change in the size of an object 902 in the field of view 110 of a camera 106. As the consist 800 approaches and moves by the object 902 (e.g., a wayside device, sign, or signal), the object 902 may change in size in the image data obtained by the camera 106 of the vehicle system 100a. As the consist 800 passes the object 902, the object 902 may appear in the image data obtained by the camera 106 of the vehicle system 100c and then change size.

If the object 902 is detected in the image data and the object 902 gets smaller in the image data over time (e.g., in the image data obtained by the camera 106 of the vehicle system 100c), then the analysis processor 116 of the imaging system 102 can determine that the camera 106 is facing opposite of the direction of travel 900 of the vehicle consist 800. Conversely, if the object 902 is progressively getting larger in the image data (e.g., in the image data obtained by the camera 106 of the vehicle system 100a), then the imaging system 102 may determine that the field of view 110 of the camera 106 is oriented in the same direction as the direction of travel 900.

Optionally, changing intensities of colors or lights in the image data may be used to determine the direction in which a camera 106 is facing. The locations of wayside signals can be updated in the memory device 114 (shown in FIG. 1) so the controller 112 and/or analysis processor 116 of the vehicle consist 800 knows which wayside signals to communicate with and where the limits of the wayside signals are located. If the analysis processor 116 identifies red, yellow, or green light (or another color) in an expected location of the wayside signal in the image data, and the light is getting more intense (e.g., brighter, as could occur in the image data obtained by the camera 106 of the vehicle system 100a as the consist 800 passes a light along the direction of travel 900), then the analysis processor 116 can determine that the camera 106 is facing toward the direction of travel 900 of the vehicle consist 800. Conversely, if the intensity of the light is decreasing (e.g., becoming dimmer, as could occur in the image data obtained by the camera 106 of the vehicle system 100c), then the analysis processor 116 can determine that the camera 106 is facing away from the direction of travel 900. The analysis processor 116 can combine this analysis of the light intensity with the changing size of the wayside device (e.g., signal) in order to determine the direction that the camera 106 is facing. Optionally, the analysis processor 116 can examine changing sizes of objects or changing light intensities, but not both, to determine orientations of cameras 106.

The analysis processor 116 can use the determination of which direction a camera is facing to direct the camera 106 to change operational settings. For example, the analysis processor 116 can determine which direction the camera 106 of the vehicle system 100c is facing using changing object sizes and/or light intensities. The analysis processor 116 can direct this camera 106 where to focus, change the field of view, or the like, based on this orientation. For example, if the image data obtained by the camera 106 of the vehicle system 100a identifies damage to the rail 204 of the route 104, then the analysis processor 116 can direct the camera 106 of the vehicle system 100c to change the focus, field of view, resolution, or the like, of the camera 106 so that the image data captures the rail 204. The analysis processor 116 could direct the camera 106 of the vehicle system 100c to focus in on the rail 204 and exclude the rail 202 from the field of view in the image data. As a result, the same track is examined by the cameras on the leading and trailing vehicles.

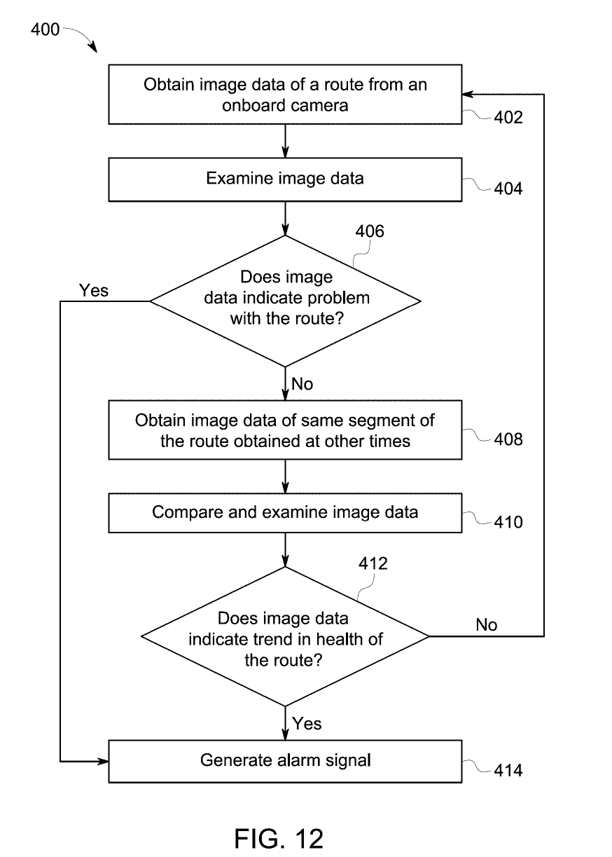

FIG. 12 illustrates a flowchart of a method 400 for imaging a route traveled by one or more vehicle systems according to one embodiment. The method 400 may be used to obtain image data of a route and to determine if one or more problems exist with the route, such as damage to the route, a deteriorating health (e.g., condition) of the route, or the like. At least one embodiment of the method 400 may be practiced using the imaging system 102 (shown in FIG. 1) described herein.

At 402, image data of the route is obtained from a camera onboard a vehicle system. For example, a camera that is positioned to obtain video of an operator disposed on the vehicle system also may obtain video of a portion of the route. This camera may be installed to monitor actions (or lack thereof) of an operator for liability or other purposes (e.g., such as in post-accident investigations or reconstructions), but that also may obtain video of a portion of the route, such as through windows of the vehicle system.

At 404, the image data is examined. As described above, the image data can be examined in real time and/or after travel of the vehicle system is complete. The image data can be examined to identify locations and/or arrangements of components of the route, such as the relative locations and/or spacing of rails of a track. The image data optionally can be examined to monitor conditions of other objects on or near the route, as described above.

At 406, a determination is made as to whether the image data indicates a problem with the route. For example, the image data can be examined to determine if the route is broken, bent, twisted, or the like, and/or if other objects are on or near the route such that the objects could cause problems for travel along the route for the vehicle system obtaining the image data and/or another vehicle system.

If the image data indicates a problem with the route, then one or more corrective actions may need to be taken. As a result, flow of the method 400 can proceed to 414. On the other hand, if the image data does not indicate such a problem, then additional image data (e.g., previously and/or subsequently acquired image data of the same segment of the route) may be examined to determine if the condition of the route is deteriorating, if foreign objects (e.g., vegetation) are moving toward the route over time, if ballast material needs cleaning and/or replacing, or the like. As a result, flow of the method 400 can proceed to 408. Alternatively, no further analysis is performed on this or other image data, and the method 400 can terminate.

At 408, additional image data of the same segment of the route can be obtained. This additional image data may be generated by one or more cameras at different times than when the image data is obtained at 402. For example, the additional image data can be generated by cameras of imaging systems on other vehicle systems on prior days, weeks, months, or years, and/or subsequent days, weeks, months, or years.

At 410, the image data and additional image data are compared with each other and examined. The image data and additional image data are compared and examined in order to determine if the image data and additional image data exhibit changes in the route over time. For example, while a single or multiple set of the image data acquired at one or more times may not indicate damage to the route due to the damage being relatively minor, examining more image data acquired over longer periods of time may illustrate a change in locations and/or damage to the route more than a smaller amount of image data and/or image data obtained over shorter time periods.

At 412, a determination is made as to whether the image data and the additional image data indicate a trend in the condition (e.g., health) of the route. For example, the image data and additional image data can be examined to determine if the route is gradually becoming more damaged, if the route is gradually changing location, if vegetation is growing toward and/or onto the route, or the like. Alternatively, the image data acquired at different times can be examined to identify damage to the route without identifying a trend in the condition of the route.

If the image data and additional image data indicate a trending problem with the route, then one or more corrective actions may need to be taken. As a result, flow of the method 400 can proceed to 414. On the other hand, if the image data and the additional image data do not indicate such a trending problem, then flow of the method 400 may return to 402 so that additional image data of the route may be obtained. Alternatively, no further analysis is performed on this or other image data, and the method 400 can terminate.

At 414, one or more alarm signals are generated. The alarm signals may be communicated from the analysis processor (which is onboard and/or off-board a vehicle system) to an off-board facility to request further inspection of the route and/or repair to the route. Optionally, an alarm signal may be communicated to one or more vehicle systems to warn the vehicle systems of the identified problem with the route. In one aspect, the alarm signal can be communicated to a scheduling system that generates schedules for vehicle systems so that the scheduling system can alter the schedules of the vehicle systems to avoid and/or slow down over the section of the route identified as having the problem.

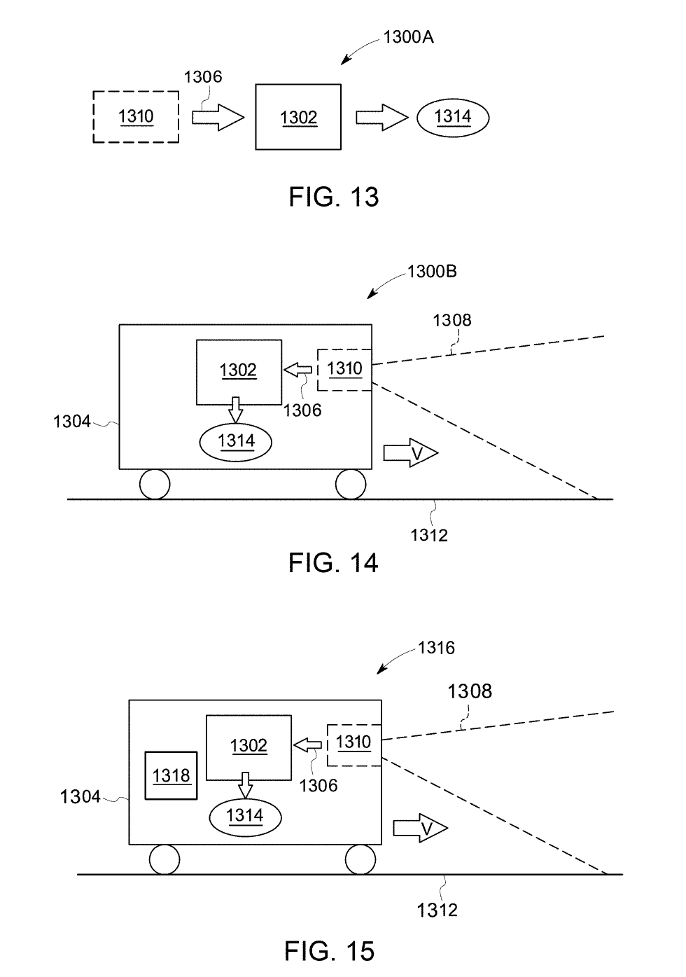

FIGS. 13-25 present a method and system to determine vehicle speed based on U.S. Ser. No. 16/158,867, filed Oct. 12, 2018, entitled Method and System to Determine Locomotive Speed that was a continuation of U.S. Ser. No. 14/979,011, filed Dec. 22, 2015, entitled METHOD AND SYSTEM TO DETERMINE VEHICLE SPEED, each of which have been incorporated in full herein.

Embodiments of the inventive subject matter illustrated in FIGS. 13-25 relate to vehicle speed determination systems and methods. The systems can be disposed onboard a vehicle that travels along a route. During movement along the route, a camera onboard the vehicle can generate image data of the route (e.g., image data of a route surface on which the vehicle travels, or areas around the route external to the vehicle). The image data is examined onboard the vehicle in order to determine a speed of the vehicle. If the camera is an existing camera that is onboard the vehicle for other purposes (e.g., as a safety-related video data recorder), the systems and methods may provide a redundant mechanism for determining vehicle speed, in instances where such a function is required, at less cost than a redundant sensor-based system, and with more accuracy than (for example) a GPS-based system. The image data may include static images (e.g., still images) and/or videos (e.g., moving images).

With reference to FIGS. 13 and 14, in one or more embodiments, systems 1300A, 1300B (e.g., vehicle speed determination systems) comprise one or more analysis processors 1302 configured to be operably disposed onboard a vehicle 1304 and configured to receive image data 1306 of a field of view 1308 of a camera 1310 operably disposed onboard the vehicle. The camera 1310 may be operably disposed onboard the vehicle by being directly or indirectly connected with the vehicle or another object that moves along with the vehicle. The camera 1310 may be disposed inside the vehicle, such as an interior camera, or on the exterior of the vehicle. At least part of the field of view of the camera includes a route 1312 of the vehicle external to the vehicle (i.e., the image data is of the field of view, which is at least partially external to the vehicle). The one or more analysis processors 1302 are further configured to determine a speed 1314 of the vehicle (e.g., a non-zero speed of when the vehicle is moving; “v” in FIG. 14 indicates movement) based at least in part on the image data 1306. The speed that is determined is an approximate measurement of the actual speed of the vehicle. In one or more embodiments, the system 1300A, 1300B is configured to automatically determine the speed 1314, without operator intervention. The processors 1302 can include or represent one or more hardware circuits or circuitry that includes and/or is coupled with one or more computer processors (e.g., microprocessors, controllers, field programmable gate arrays, integrated circuits, or other electronic logic-based devices).

In the embodiment of the system 1300B shown in FIG. 14, the camera 1310 is operably disposed onboard the vehicle 1304 and is oriented such that the field of view 1308 of the camera includes the route 1312, namely, the field of view includes a road surface or a guided track that the vehicle 1304 travels on. Guided track refers to a single rail (such as for a monorail), a set of parallel rails (such as for a train that includes locomotives and non-propulsion rail cars for carrying passengers and/or cargo), wayside guides that keep a vehicle within a designated area, cables along which a vehicle travels, etc.

In another embodiment, with reference to FIG. 15, a system 1316 (e.g., vehicle speed determination system) is generally similar to the systems shown in FIGS. 13 and 14, and further comprises a vehicle control system 1318 configured to be operably disposed onboard the vehicle 1304. The vehicle control system 1318 includes or represents hardware circuitry that includes and/or is coupled with one or more computer processors (e.g., microprocessors, controllers, field programmable gate arrays, integrated circuits, or other electronic logic-based devices). The vehicle control system 1318 may generate electronic signals communicated to propulsion systems (e.g., motors, alternators, generators, etc.) and/or brake systems to control movement of the vehicle, signals communicated to an output device (e.g., a display, speaker, etc.) to report the vehicle speed, signals communicated to an off-board location (e.g., via transceiving circuitry of the control system) for monitoring the vehicle speed, etc. The vehicle control system 1318 is configured to automatically control the vehicle based on the speed 1314 that is determined, control display of the speed that is determined to an operator, control storage onboard the vehicle of information of the speed that is determined, and/or control communication off board the vehicle of the information of the speed that is determined. For example, the vehicle control system 1318 may be configured to automatically control the vehicle based on the speed 1314 that is determined. If the vehicle control system 1318 determines that the vehicle speed is faster than a designated speed, then the vehicle control system 1318 may automatically operate to slow or stop movement of the vehicle.

As another example, if the vehicle control system 1318 determines that the vehicle speed is slower than a designated speed, then the vehicle control system 1318 may automatically operate to speed up movement of the vehicle. Optionally, if the vehicle control system 1318 determines that the vehicle speed is faster than a designated speed, then the vehicle control system 1318 may automatically generate a signal to notify an operator of the vehicle to slow or stop movement of the vehicle. As another example, if the vehicle control system 1318 determines that the vehicle speed is slower than a designated speed, then the vehicle control system 1318 may automatically generate a signal to notify the operator to speed up movement of the vehicle. The designated speed may be a speed limit of the route, a speed designated by a trip plan that designates speeds of the vehicle as a function of time, distance along a route, and/or locations along the route, or another speed.

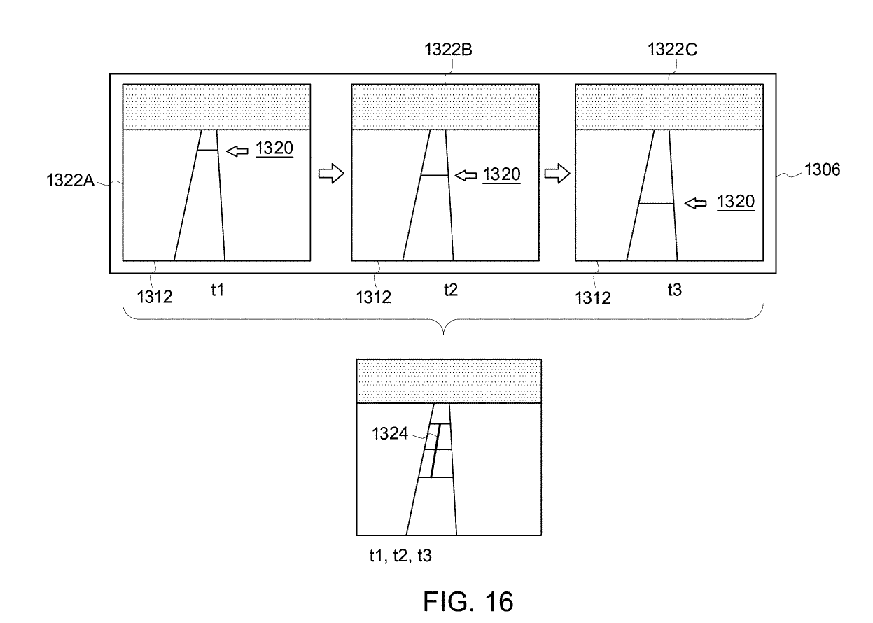

In another embodiment, with reference to FIG. 16, the one or more analysis processors 1302 are configured to determine (e.g., automatically) the speed 1314 by the following process: (i) identify at least one image feature 1320 of the route in the image data 1306 that moves in time across plural frames 1322a, 1322b, 1322c, etc. of the image data (t1, t2, and t3 represent different, successive points in time); (ii) determine a total pixel distance 1324 by which the at least one image feature has moved (in the bottom portion of FIG. 14, the three frames 1322a, 1322b, 1322c are shown in a composite or overlaid view, to graphically represent the total pixel distance 1324 for the sake of illustration); (iii) determine a pixel rate of change based on the total pixel distance 1324 and a frame rate at which the image data is captured; and (iv) determine the speed 1314 based on the pixel rate of change and a correlation of a unit pixel distance to a unit route distance. For example, pixel rate of change may be multiplied by the ratio of unit route distance to unit pixel distance, resulting in a ratio of route distance to time, which is equivalent to vehicle speed.

The image feature can be a feature of interest, such as a rail tie, insulated joint, sign, tree, road stripe, crossing, etc., that is stationary with respect to the route being traveled upon. The images or frames obtained at different times can be examined in order to determine a total pixel distance by which the feature of interest has moved. The total pixel distance represents the distance (e.g., in terms of pixel size, the number of pixels, etc.) that the image feature has changed in the image data. The pixel rate of change can represent the speed at which the location of the image feature has changed in the images. For example, if two images are acquired at times that are one second apart (e.g., the frame rate is one frame per second) and an image feature has moved fifty pixels between the images, then the pixel rate of change may be fifty pixels per second. The vehicle speed can be determined based on the pixel rate of change and a correlation factor of a unit pixel distance to a unit route distance. For example, the pixel rate of change may be multiplied by the ratio of unit route distance to unit pixel distance, resulting in a ratio of route distance to time, which is equivalent to vehicle speed.

To identify the at least one image feature 1320 of the route in the image data 1306 that moves in time across plural frames 1322a, 1322b, 1322c, etc. of the image data, the one or more analysis processors may be configured to convert the image data to or generate the image data as wireframe model data, as described in U.S. Publication No. 2015-0294153A1, dated Oct. 15, 2015, which is titled “Route Damage Prediction System And Method” (the “'294 application”), the entire disclosure of which is incorporated by reference in its entirety. The wireframe model data can be used to identify image features common to plural frames.

The frames 1322a, 1322b, 1322c, etc. may each be a respective digital image formed from plural pixels of varying color and/or intensity. Pixels with greater intensities may be lighter in color (e.g., more white) while pixels with lesser intensities may be darker in color. In one aspect, the one or more image analysis processors are configured to examine the intensities of the pixels to determine which one or more features are common to plural frames. For example, the processor(s) may select those pixels having a particular combination of features (e.g., a line of more intense pixels bordering a line of less intense pixels, arranged generally horizontally in the field of view, such as might represent a rail tie, for example), and look for a match in subsequent frames. In one embodiment, the analysis processor(s) only use the intensities of pixels to identify features of interest in the images or frames, which are then used to determine the vehicle speed, as described herein. Alternatively, the analysis processor(s) may use other characteristics of the images to detect the features of interest, such as chromacity or other characteristics.

To explain further, the camera 1310 can obtain several images/frames 1322a, 1322b, 1322c over time of an upcoming segment of the route 1312 during movement of the vehicle 1304 along the route 1312. The analysis processor(s) 1302 may control the camera 1310 to acquire the images/framers at relatively fast frame rates, such as at least by obtaining 300 images per second per camera, 1320 images per second per camera, 72 images per second per camera, 48 images per second per camera, 30 images per second per camera, 24 images per second per camera, or another rate.

The analysis processor(s) then compares the images obtained by the camera to identify differences in the images. These differences can represent image features, which are objects on or near the segment of the route that the vehicle is traveling toward. FIG. 14 includes an overlay representation of three images/frames acquired by the camera and overlaid on each other according to one example of the inventive subject matter described herein. The overlay representation represents three images of the same segment of the route taken at different times by the camera and combined with each other. The analysis processor(s) may or may not generate such an overlay representation when examining the images for an object.

As shown in the representation, the route is a persistent object in that the route remains in the same or substantially same location in the images/frames obtained at different times. This is because the route is not moving laterally relative to the direction of travel of the vehicle (shown in FIG. 14) as the vehicle travels along the route. The analysis processor(s) can identify the route by examining intensities of pixels in the images, as described above, or using another technique.

Also as shown in the overlay representation, an image feature appears in the frames. The analysis processor(s) can identify the image feature by examining intensities of the pixels in the images/frames (or using another technique) and determining that one or more groups of pixels having the same or similar (e.g., within a designated range) of intensities appear in locations of the images that are close to each other.

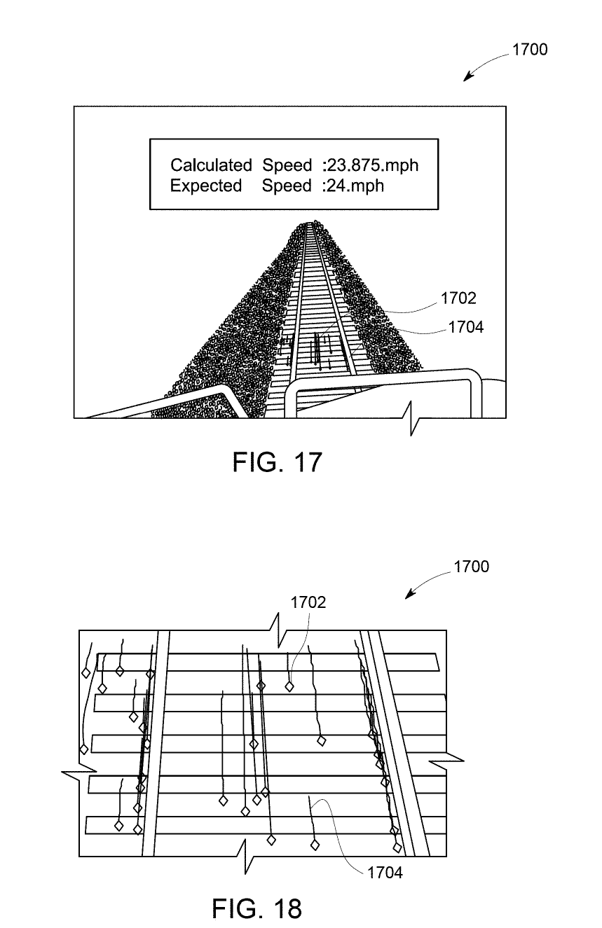

FIG. 17 illustrates a single frame or image 1700 acquired by the camera 1310 shown in FIGS. 13 through 13 according to one example. FIG. 18 illustrates a portion of the frame or image 1700 shown in FIG. 17. The image 1700 shown in FIGS. 17 and 18 includes several features of interest 1702. The features of interest 1702 may be objects appearing in two or more images acquired at different times. For example, the features of interest 1702 may be edges of railroad ties, trees, signs, insulated joints in a rail, telephone poles, power lines, stripes on pavement (e.g., between neighboring lanes of a road), etc. The features of interest 1702 may be stationary with respect to the route so that changes in the location of the features of interest 1702 in images or frames acquired at different times can be used to determine the speed of the vehicle.

The analysis processors may identify one or more features of interest 1702 in two or more of the images acquired at different times and examine the images 1700 to determine differences in where the features of interest 1702 are located in the images 1700. Based on the differences, the analysis processors can determine how fast the vehicle is moving and/or a direction of movement (or heading) of the vehicle.

In one embodiment, the analysis processor(s) may identify the features of interest using one or more convolution filters. A convolution filter may be applied to an image or video frame in order to sharpen the image or frame, detect edges in the image or frame, etc. As one example, pixel intensities or other values of the pixels in the image or frame are converted or examined as a two dimensional matrix. This results in the image being examined as a matrix of numbers representative of pixel intensities or other pixel values (referred to as an image matrix). A smaller matrix (e.g., a matrix having a smaller number of rows and/or columns than the matrix representative of the image or frame) is assigned values and is applied to the image matrix. The smaller matrix may be applied to the image matrix by overlaying the smaller matrix onto the image matrix and multiplying the values of the smaller matrix and the image matrix. For example, if the top left value in the image matrix has a value of 20 and the top left value in the smaller matrix has a value of −1, then applying the smaller matrix to the image matrix results in the top left value in combination of the matrices having a value of −20. The values of the combination of the matrices are combined, which can be achieved by summing the values. For example, if the combination of the matrices results in a matrix having values of −20, 15, −25, 120, 88, 111, −77, −25, then the combination of the matrices can be 187. Optionally, this sum can be divided by a divisor value and/or a bias value may be added. The combination of the matrices (with or without the divisor and/or bias) provides a new pixel value. The image matrix is examined again to determine if one or more values in the image matrix are greater than or less than the value of the combined matrices. For example, if the smaller matrix is a 3 by 3 matrix, then the value of the center portion of the image matrix that the smaller matrix was combined with is compared to the value of the combined matrices. If this pixel value is greater than or equal to the value of the combined matrices, then the value of the pixel in the image is changed to the value of the combined matrices. But, if the pixel value is less than the value of the combined matrices, then the value of the pixel in the image is changed to zero or another designated value. For example, if the value of the center pixel in the 3 by 3 portion of the image matrix that was combined with the smaller matrix is 1390, then the value of this pixel in the image is changed to 1387. But, if the value of this center pixel is 65, then the value of this pixel in the image is changed to 0. The smaller matrix may be combined with other portions of the image matrix to combine the smaller matrix with the different portions of the image matrix and modify pixel values of the image as described above. The values of the image can be changed to cause edges or other objects to be more apparent or easily identified by the analysis processor(s). The analysis processor(s) may then detect the edges or other portions as features of interest.

Trace lines 1704 illustrate how far the different features of interest 1702 have moved between the images 1700. Longer trace lines 1704 indicate that the location of the corresponding feature of interest 1702 has changed more between the images 1700 than shorter trace lines 1704. A trace line 1704 represents the difference in a feature of interest 1702 that can be used by the analysis processors to determine the speed and/or heading of the vehicle. The analysis processor may be calibrated or programmed with a correlation factor or ratio between distance in the images 1700 and a distance along the route. A correlation factor or ratio can be a numerical value indicating how far a distance in an image represents along the route. For example, one hundred pixels in the images 1700 can represent twenty centimeters along the route. The correlation factor or ratio can be used by the analysis processors to determine how fast the vehicle is moving.

For example, if a location of a feature of interest 1702 moves 294 pixels between images 1700 and one hundred pixels in an image 1700 represents ten centimeters along the route, then the change in location of the feature of interest 1702 between the images 1700 can indicate that the vehicle has moved 29.4 centimeters between the times that the images 1700 were obtained. If the images 1700 were obtained sequentially at a rate of thirty frames per second, then the analysis processor may determine that the vehicle has moved 29.4 centimeters in one thirtieth of a second, or 31.7 kilometers per hour.

In one aspect, the correlation factor is different for changes in image distance in different locations of the image. For example, if a feature of interest moves by 100 pixels in the top portion or zone of an image, this may represent movement of 0.5 meters along the route. But, if the same feature of interest moves by 100 pixels in the bottom portion of the image (where the pixels in the top and bottom portions are the same size), this may represent movement of 0.3 meters along the route. The correlation factor may be different for different regions or portions of the image or frame due to the angle at which the camera is oriented relative to the route. Therefore, identical changes in location of a feature of interest in different zones of an image may represent different changes in location along the route. The different correlation factors may be used to provide a more accurate determination of moving speed of the vehicle.

The analysis processor(s) can track multiple features of interest in multiple images or frames to determine the speed of the vehicle. In one aspect, the analysis processor(s) may use those features of interest that are detected by the analysis processor(s) in at least a designated, non-zero threshold number of the images or frames, such as ten images or frames (or another value). If a feature of interest appears in less images or frames than this threshold number, then that feature of interest may not be used to determine the speed of the vehicle. Those features of interest that appear in at least this threshold number of images or frames can be used to determine the speed of the vehicle.

In embodiments, the features of interest are not designated or otherwise known to the system (e.g., to the analysis processor(s)) ahead of time, before the image data is collected and analyzed. That is, the features of interest can be any qualifying features (e.g., the features are persistent across multiple successive image frames and/or have intensity characteristics or other characteristics suitable for assessing pixel distance, as described herein), and are not arranged or distributed along the route for purposes of determining vehicle speed using video analytics. This does not preclude the possibility that such pre-determined or pre-established route features (e.g., designated route markers, and/or specially encoded or marked route markers) could be features of interest from an incidental standpoint. Rather, it means that such pre-determined or pre-established route features are not required for operation of the system here.

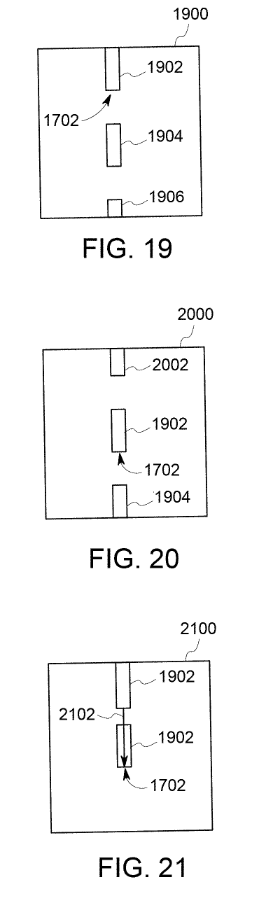

FIG. 19 illustrates an image or frame 1900 obtained by the camera 1310 at a first time according to one example. FIG. 20 illustrates another image or frame 2000 obtained by the camera 1310 at a subsequent, second time. The images or frames 1900, 2000 can be acquired of portions of a route, such as a road. The analysis processors can identify one or more features of interest 1702, such as stripes 1902, 1904, 1906 painted on the road in the illustrated example. Alternatively, the features of interest 1702 may include rail ties, signs, etc. A feature of interest 1702 can be an entire stripe or a portion of a stripe, such as an edge of a stripe. As shown in FIGS. 19 and 20, the locations of the stripes 1902, 1904, 1906 change between the image 1900 and the image 2000, with the stripe 1906 no longer visible in the subsequent image 2000 and an additional stripe 2002 visible in the image 2000.

FIG. 21 illustrates an overlay image 2100 of part of image 1900 shown in FIG. 19 and part of the image 2000 shown in FIG. 20. The overlay image 2100 illustrates the change in position of the stripe 1902 between the image 1900 and the image 2000. The other stripes 1904, 1906, 2002 are not shown in the overlay image 2100. The analysis processors can examine changes in locations of the feature of interest 1702, such as a bottom edge of the stripe 1902, between the images 1900, 2000 to identify a difference 2102 in the feature of interest 1702. In the overlay image 2100, the difference 2102 in the feature of interest 1702 is shown as a vector having a direction that is opposite of a direction of travel of the vehicle and a magnitude that is proportional to the speed of the vehicle. As described above, the analysis processors can examine the magnitude of the difference 2102 to determine how fast the vehicle is moving, such as by scaling the magnitude of the difference 2102 by a correlation factor that relates pixel sizes or other distances in the images to distances along the route. The analysis processors optionally can examine the orientation or direction of the difference 2102 to determine the direction of movement or heading of the vehicle. For example, the analysis processors may identify the direction of movement or heading of the vehicle as being opposite of the difference 2102 shown in FIG. 21.

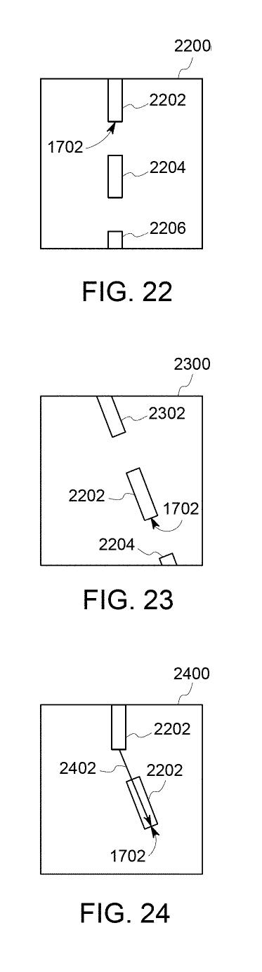

FIG. 22 illustrates an image or frame 2200 obtained by the camera 1310 at a first time according to one example. FIG. 23 illustrates another image or frame 2300 obtained by the camera 1310 at a subsequent, second time. The images or frames 2200, 2300 can be acquired of portions of a route, such as a road. The analysis processors can identify one or more features of interest 1702, such as stripes 2202, 2204, 2206 painted on the road in the illustrated example. Alternatively, the features of interest 1702 may include rail ties, signs, etc. A feature of interest 1702 can be an entire stripe or a portion of a stripe, such as an edge of a stripe. As shown in FIGS. 22 and 23, the locations of the stripes 2202, 2204, 2206 change between the image 2200 and the image 2300, with the stripe 2206 no longer visible in the subsequent image 2300 and an additional stripe 2302 visible in the image 2300.

FIG. 24 illustrates an overlay image 2400 of part of image 2200 shown in FIG. 22 and part of the image 2300 shown in FIG. 23. The overlay image 2400 illustrates the change in position of the stripe 2202 between the image 2200 and the image 2300. The other stripes 2204, 2206, 2302 are not shown in the overlay image 2400. The analysis processors can examine changes in locations of the feature of interest 1702, such as a bottom edge of the stripe 2202, between the images 2200, 2300 to identify a difference 2402 in the feature of interest 1702. In the overlay image 2400, the difference 2402 in the feature of interest 1702 is shown as a vector having a direction that is opposite of a direction of travel of the vehicle and a magnitude that is proportional to the speed of the vehicle. As described above, the analysis processors can examine the magnitude of the difference 2402 to determine how fast the vehicle is moving, such as by scaling the magnitude of the difference 2402 by a correlation factor that relates pixel sizes or other distances in the images to distances along the route.

The analysis processors optionally can examine the orientation or direction of the difference 2402 to determine the direction of movement or heading of the vehicle. For example, the change in positions of the stripes in the images 2200, 2300 indicate that the vehicle is turning or otherwise changing heading. The analysis processors may identify the direction of movement or heading of the vehicle as being opposite of the difference 2402 shown in FIG. 24.

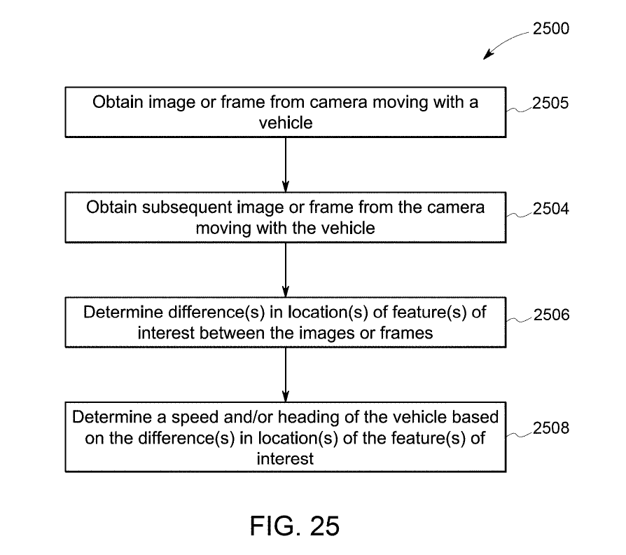

FIG. 25 illustrates a flowchart of one embodiment of a method 2500 for determining a vehicle speed. The method 2500 may be performed by one or more embodiments of the vehicle speed determination systems described herein. At 2502, an image or frame of a video is obtained from a camera that is moving with a vehicle. The camera may be attached to the vehicle or otherwise moving with the vehicle. At 2504, another image or frame of the video is obtained at a subsequent time from the camera. For example, the images or frames may represent a field of view of the camera at different times. At 2506, one or more differences in locations of one or more features of interest in the images or frames are determined. For example, the location of a rail tie, insulated joint, sign, crossing, building, road stripe, etc. may be identified in the images and a difference in the locations of the identified feature of interest between the images may be determined. In one aspect, changes in locations of several features of interest may be determined. At 2508, a speed and/or heading of the vehicle are determined from the differences in location of the one or more features of interest. As described above, the magnitude of the change in location of one or more features of interest between the images or frames may be proportional to the speed of the vehicle and a direction of the change in location of the one or more features of interest between the images or frames may be opposite in direction of the heading of the vehicle. Changes in the locations of several different features of interest may be used and an average, median, or other statistical calculation may be made of the changes to determine the vehicle speed and/or heading. The speed and/or heading that are determined may be used to implement one or more control actions. For example, in response to determining that the vehicle speed determined from the images is faster than a designated speed or speed limit, a control system of the vehicle may automatically slow or stop movement of the vehicle. In response to determining that the vehicle speed determined from the images is slower than a designated speed or speed limit, a control system of the vehicle may automatically increase the speed of the vehicle or instruct an operator that the speed of the vehicle can be increased.

Embodiments of the inventive subject matter relate to analyzing video data collected from an on-board video camera mounted on a vehicle facing a route (e.g., a locomotive facing a track). Using this route video an image analysis technique is applied to one or more frames of the video and the frames can be processed in real time. Using feature detection on individual frames and using the video frames per second attribute an idea of rate of change of pixels is calculated. Mapping the pixel distance to real track distance this pixel rate is converted to speed. Thus, a gauge of the vehicle speed is obtained purely by video analysis.

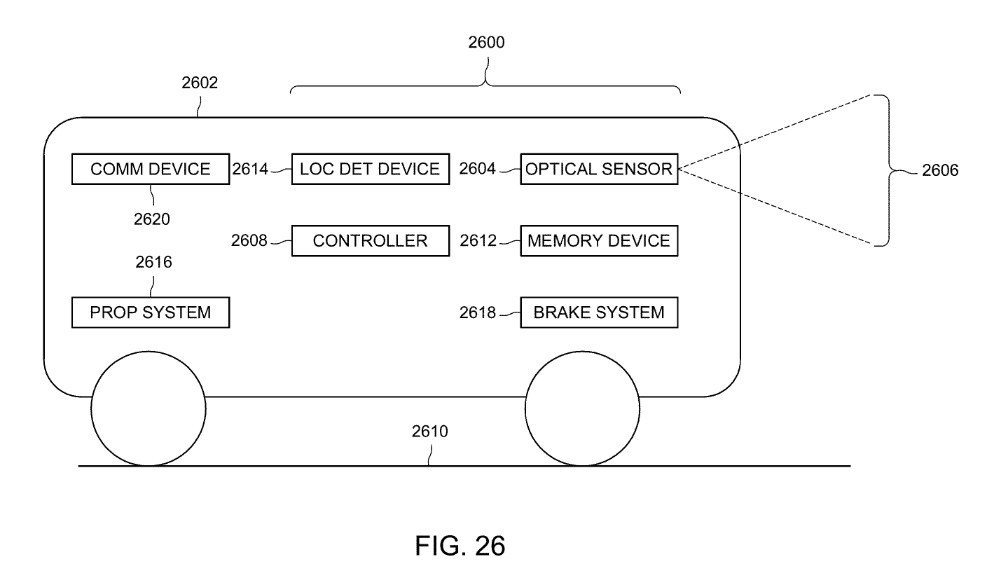

FIGS. 26-30 present a visual object detection system for a vehicle based on U.S. Ser. No. 15/862,238 filed Jan. 4, 2018, and entitled Visual Object Detection which has been incorporated in full herein.

The inventive subject matter described in FIGS. 26-30 provides systems and methods that can automatically determine how far objects appearing in visual data obtained by an optical sensor are from the optical sensor. The systems and methods can examine features in the visual data that have known dimensions to determine a depth scale for objects appearing in the visual data. For example, the systems and methods can calculate how far two surfaces or objects are from each other in the visual data, such as in terms of the number of pixels that separate the surfaces or objects in the visual data. The systems and methods can determine how far these surfaces or objects actually are from each other (e.g., outside of the visual data), and determine a scale that translates the number of pixels separating objects in the visual data to the separation distance between the objects outside of the visual data. This scale can be used to determine how far other objects are from the optical sensor, such as by determining depth in the 2D visual data. This depth information can be used to determine how far the objects are from the optical sensor, geographic locations of the objects, relative locations of the objects from the optical sensor or a vehicle carrying the optical sensor, etc. In one embodiment, the depth information can be used in conjunction with the location of the vehicle and/or the speed at which the vehicle is moving to determine the geographic location of an object. This geographic location can be used to create, update, and/or verify information included in a database (or other memory structure) that indicates locations of wayside equipment for a vehicle transportation system.

FIG. 26 illustrates one embodiment of a visual object detection system 2600. The detection system is shown as being onboard a vehicle 2602 traveling along a route 2610, but optionally may be off-board the vehicle or may be disposed elsewhere. One or more components of the detection system may be onboard the vehicle, while one or more other components of the detection system may be onboard another vehicle or off-board all other vehicles. The vehicle can represent a rail vehicle, an automobile, a truck, a bus, a mining vehicle, another type of off-highway vehicle (e.g., a vehicle that is not designed or is not legally permitted for travel on public routes), a marine vessel, an aircraft (e.g., a manned or unmanned aerial vehicle), or the like.

The detection system 2600 includes an optical sensor 2604 that senses light or other information (e.g., infrared radiation) to generate visual data representative of objects appearing within a field of view 2606 of the optical sensor. In one embodiment, the optical sensor is a camera that generates 2D images and/or 2D videos representative of the objects appearing in the field of view. The optical sensor may be mounted inside the vehicle, such as within a cab in which an operator of the vehicle is located, with the field of view of the optical sensor capturing objects outside of the vehicle and within the field of view of the optical sensor through one or more windows or openings of the vehicle. Alternatively, the optical sensor may be disposed outside of the vehicle.

In one embodiment, the detection system uses only the optical sensor to both obtain visual data of objects outside of the vehicle and to determine depth within the visual data (e.g., the distance from the optical sensor to the objects appearing in the visual data). For example, the detection system may use only a single camera, and not multiple cameras (e.g., using a stereoscopic technique), to determine depth within the visual data. As another example, the detection system may use only the single optical sensor, and not another type of sensor, to determine depth. The detection system may not use radar, lidar, sonar, structured light, or the like, to determine depth from the optical sensor to an object. Instead, the detection system may only examine information contained within the 2D visual data to determine depth of objects within the visual data.

The detection system includes or is connected with a controller 2608. The controller represents hardware circuitry that includes or is connected with one or more processors (e.g., microprocessors, field programmable gate arrays, integrated circuits, or the like) that perform the functions of the controller described herein. The controller receives the visual data from the optical sensor and examines the visual data to determine how far objects shown in the visual data are from the optical sensor (and/or the vehicle).

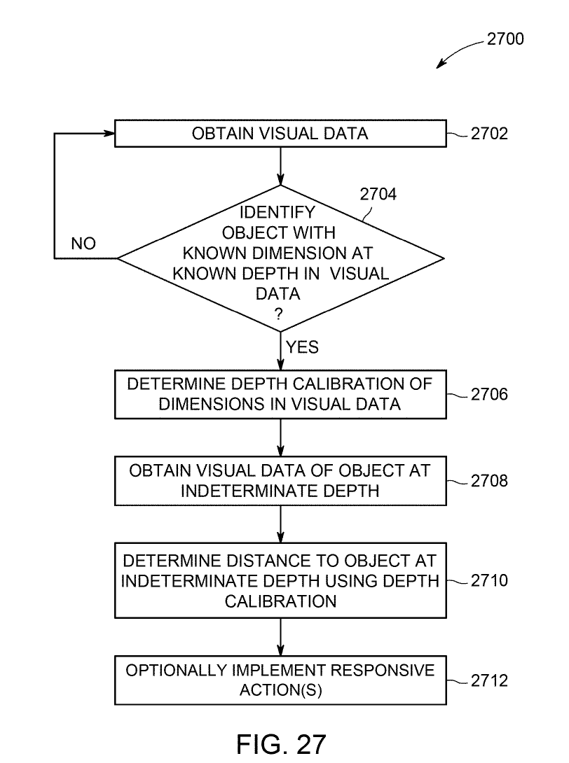

With continued reference to the detection system 2600 shown in FIG. 26, FIG. 27 illustrates a flowchart of one embodiment of a method 2700 for detecting objects in visual data and/or determining depth of objects in visual data. The method can be performed by the controller. For example, the controller may operate under the instruction of one or more software applications that direct the operations described in connection with the flowchart. As another example, the flowchart may represent an algorithm that may be used to create one or more software applications that direct operation of the controller.

At 2702, visual data is obtained. The visual data may be 2D visual data provided by or output by the optical sensor 2604 (shown in FIG. 26). The visual data may be provided during movement of the vehicle 2602 (shown in FIG. 26) or after completion of a segment or all of a trip of the vehicle.

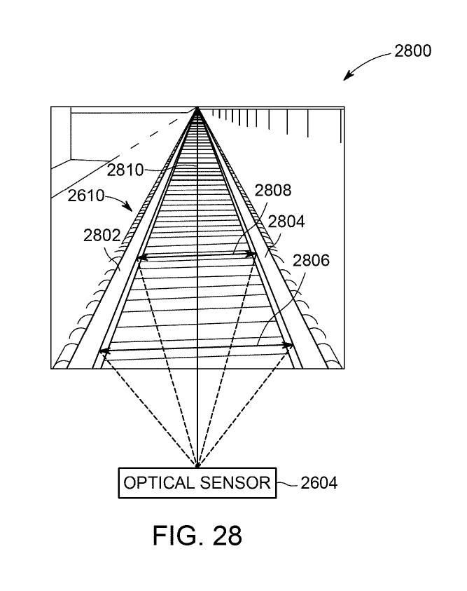

With continued reference to both the detection system 2600 shown in FIG. 26 and the flowchart of the method 2700 shown in FIG. 27, FIG. 28 illustrates one example of 2D visual data 2800 generated by the optical sensor 2604 shown in FIG. 26. The visual data 2800 shows a segment of the route 2610 (shown in FIG. 26) on which the vehicle 2602 (shown in FIG. 26) is traveling that is within the field of view 2606 (shown in FIG. 26) of the optical sensor. The route includes reference portions 2802, 2804 that are a known distance 2806, 2808 away from each other outside of the visual data. For example, the route may be a track having rails that are a designated distance (e.g., gauge) away from each other to allow a rail vehicle to travel along the route. Optionally, the portions spaced apart by the known separation distance may be paint markings of a road, markings on a sign alongside the route, markings on a building, or the like. The portions, markings, etc., that are spaced apart from each other by a known distance may be referred to as reference markers. The distances 2806, 2808 between the markings may be measured along one or more directions that are transverse to a direction of travel of the vehicle, such as a direction that is perpendicular to a center line of the route being traveled upon by the vehicle.

At 2704 in the flowchart of the method 2700 shown in FIG. 27, a determination is made as to whether objects with known dimensions at a known depth are identified in the visual data. The controller may attempt to identify the portions of the route using optical detection techniques, such as detecting which pixels in the visual data having chromacities, colors, intensities, etc., that are different from some pixels but that are similar to other nearby pixels. The controller may attempt to determine if the portions of the route having the known separation distance at a known distance away from the optical sensor. For example, the controller may examine how far apart the rails of the track are from each other along the line representative of the separation distance 2806 in FIG. 28 and/or other along the line representative of the separation distance 2808 in FIG. 28. These lines at which the separation distance 2806 and/or 2808 are measured may be at knows distances from the optical sensor, such as ten meters, twenty meters, etc. If the controller is unable to identify the portions of the route having the known separation distance at the known distance or depth from the optical sensor, then flow of the method 2700 may return toward 2702 to obtain additional visual data. But, if the controller is able to identify the portions of the route having the known separation distance at the known depth, then flow of the method 2700 can proceed toward 2706.

At 2706, the depth of objects in the visual data is calibrated. The known dimension of the object in the visual data may be the separation distance 2806, 2808 between the portions 2702, 2704 of the route as determined by the controller. The actual distance between the portions of the route may be known to the controller, such as this information being stored in a memory device 2812 (e.g., one or more servers, computer hard drives, databases, etc.). The controller can convert the separation distance measured in the visual data to the actual distance between the portions of the route.

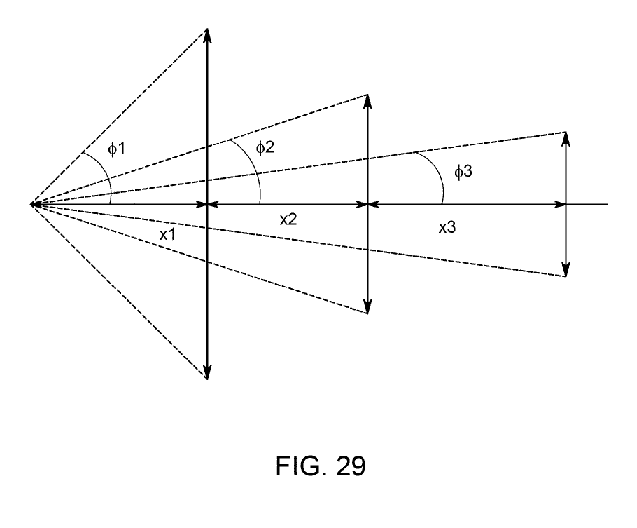

FIG. 29 illustrates one example of how the controller can convert the known dimension of an object in the visual data to an external scale. A distance x1 in FIG. 29 represents the distance (outside of the visual data) from the optical sensor to the location where the separation distance 2806 is measured in the visual data. A distance x2 in FIG. 29 represents the distance (outside of the visual data) from the optical sensor to the location where the separation distance 2808 is measured in the visual data. An angle Φ1 in FIG. 29 represents the angle between a centerline 2810 (shown in FIG. 28) of the route (or the center location between the portions of the route separated by the known distance) and one of the portions of the route at the location where the separation distance 2806 is measured in the visual data. An angle Φ2 in FIG. 29 represents the angle between the centerline of the route and one of the portions of the route at the location where the separation distance 2808 is measured in the visual data.

Based on this information, the controller may determine a calibration constant or scale to be used for determining depth within the visual data. For example, from this information, the controller can determine:

tan Φ₁*x₁=tan Φ₂*(x₁+x₂) (Eqn. 1)

This relationship can be used to determine the depth distance (e.g., the distance from the optical sensor) to another location in the visual data. The other location may be represented by a distance x3 from the optical sensor along the centerline of the route, with the angle Φ3 representing the angle between the centerline of the route to one of the portions 2802, 2804 of the route at the distance x3 from the optical sensor, as shown in FIG. 29. The controller can determine the depth or distance from the optical sensor to the other location at x3 based on tan Φ₁*x₁ being used as a calibration factor:

tan Φ₁*x₁=tan Φ₃*(x₁+x₂+x₃) (Eqn. 2)

At 2708 in the flowchart of the method 2700 shown in FIG. 27, visual data that represents locations of one or more objects at unknown or indeterminate depths or distances from the optical sensor is obtained. For example, the optical sensor may generate visual data showing the location of wayside equipment at an unknown distance from the optical sensor.

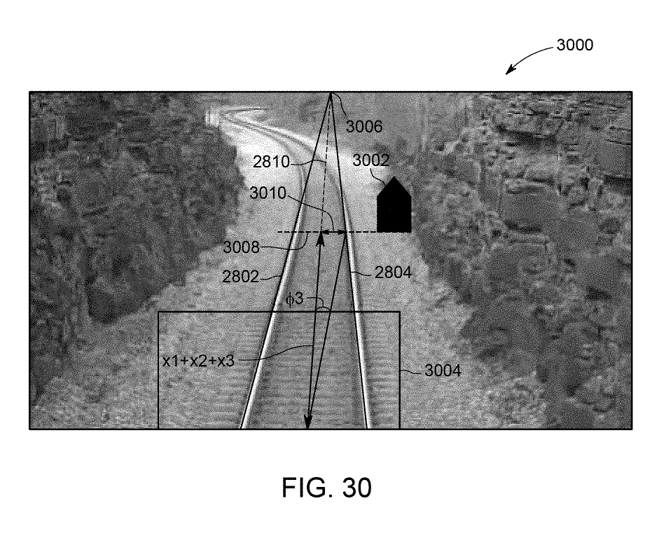

FIG. 30 illustrates additional visual data 3000 provided by the optical sensor shown in FIG. 26 according to one example. An object 3002 is shown in the visual data 3000, and may represent wayside equipment, such as a signal, sign, gate, or the like.

At 2710 in the flowchart of the method 2700 shown in FIG. 27, the distance to the object (from the optical sensor) is determined using the depth calibration described above. The controller can determine how far the object 3002 is from the optical sensor by solving for Equation #2 shown above in one embodiment. The controller may identify the portions 2802, 2804 of the route as described above, and determine the centerline 2810 between these portions 2802, 2804, as shown in FIG. 30. The segments of the portions 2802, 2804 of the route in a near field 3004 of the optical sensor and the center line 2810 may appear to converge toward a vanishing point 3006, also as shown in FIG. 30.

The controller can determine the total distance (x1+x2+x3) from the optical sensor to the object 3002 along the centerline 2810 of the route. The controller can determine this distance by identifying the portion of the object 3002 that is closest to the optical sensor in the visual data and identifying an intersection between a line 3008 that is representative of this portion of the object 3002 and the centerline 2810. The total distance (x1+x2+x3) may then be measured to this intersection along the centerline 2810.

The controller can determine the angle Φ3 by calculating the ratio between a distance 3010 in the visual data (e.g., the number of pixels measured along the line 3008 from the centerline 2810 to either portion 2802, 2804 of the route) and a distance along the centerline in the visual data (e.g., the number of pixels) from the optical sensor to the line 3008. The controller may then calculate the distance from the optical sensor to the object 3002 by solving for (x1+x2+x3) in Equation #2:

$$( {x}_{1} + {x}_{2} + {x}_{3} ) = \frac{tan {φ}_{1} * {x}_{1}}{tan {φ}_{3}}$$

This distance (x1+x2+x3) can be the actual distance from the optical sensor to the object, such as the distance that separates the vehicle from the object.

At 2712, the method 2700 optionally includes implementing one or more actions responsive to determining the distance from the optical sensor (or vehicle) to the object. One action may be to record the location of the object in the memory of the vehicle. For example, the vehicle may be traveling to determine locations of wayside equipment for creation or updating of a database of wayside equipment locations. Responsive to determining how far the object is from the vehicle, the controller may determine the location of the vehicle from a location determining device 2614 (“Loc Det Device” in FIG. 26), such as a global positioning system (GPS) receiver. The controller may then determine where the object is located (e.g., an absolute position or geographic location of the object instead of merely the distance of the object from the vehicle) based on the distance from the vehicle to the object. This location may be recorded in the memory device of the vehicle and/or communicated to an off-board location via a communication device 2620. The communication device includes transceiver circuitry that includes and/or is connected with antennas for wirelessly communicating information via the off-board location(s).

Another action may be to change movement of the vehicle. For example, responsive to determining that the vehicle is closer to the object than a designated safety distance (e.g., three meters, ten meters, one hundred meters, etc.), the controller may automatically generate and communicate a control signal to a propulsion system 2616 (“Prop System” in FIG. 26) and/or a brake system 2618 (shown in FIG. 26) of the vehicle to slow or stop movement of the vehicle. The propulsion system 2616 can include one or more engines, alternators/generators, motors, and the like, that generate tractive effort to propel the vehicle. The brake system 2618 can include one or more air brakes, friction brakes, etc., that generate braking effort to slow or stop movement of the vehicle. Responsive to receiving the control signal, the propulsion system and/or brake system may automatically slow or stop movement of the vehicle.

In one example of the inventive subject matter described herein, a vehicle system (e.g., a wayside device imaging system) includes a lead vehicle and a secondary vehicle coupled to the lead vehicle. The vehicle system also includes a digital camera and one or more analysis processors. The digital camera is configured to be disposed in a lead vehicle to generate image data within a field of view of the camera. The field of view includes at least a portion of the lead vehicle and one or more wayside devices disposed along a route being traveled by the lead vehicle. The one or more analysis processors are configured to examine the image data generated by the camera to identify a condition of the one or more wayside devices. The condition includes at least one of damage to the one or more wayside devices, a missing wayside device, deterioration of the one or more wayside devices, or a change in terrain at or near the one or more wayside devices.

In one aspect, the condition that is identified includes only one of the damage to the one or more wayside devices, the missing wayside device, the deterioration of the one or more wayside devices, or the change in terrain at or near the one or more wayside devices. Optionally, the condition that is identified includes all of the damage to the one or more wayside devices, the missing wayside device, the deterioration of the one or more wayside devices, or the change in terrain at or near the one or more wayside devices. Alternatively, the condition that is identified includes two to three, but not all, of the damage to the one or more wayside devices, the missing wayside device, the deterioration of the one or more wayside devices, or the change in terrain at or near the one or more wayside devices.

In another aspect, the condition that is identified includes the damage to the route, the deteriorating condition of the route, and the condition of the one or more wayside devices. The condition of the one or more wayside devices can include damage to the one or more wayside devices, a missing wayside device, deterioration of the one or more wayside devices, and a change in terrain at or near the one or more wayside devices.

Optionally, the condition that is identified includes damage to the route and a deteriorating condition of the route, but does not include damage to the one or more wayside devices, the missing wayside device, the deterioration of the one or more wayside devices, or the change in terrain at or near the one or more wayside devices.

In another aspect, the condition that is identified includes damage to one or more wayside devices, a missing wayside device, deterioration of the one or more wayside devices, and a change in terrain at or near the one or more wayside devices, but does not include damage to the route or a deteriorating condition of the route.

In one aspect, the digital camera is a high definition camera.

In one aspect, the one or more analysis processors are configured to be disposed onboard the lead vehicle for examination of the image data.

In one aspect, the one or more analysis processors are configured to identify the condition of the one or more wayside devices based on at least one of an edge detection algorithm, pixel metrics, an object detection algorithm, baseline image data, or a pixel gradient in the image data.

In one aspect, the one or more wayside devices include a signaling light and the one or more analysis processors are configured to identify a broken or missing light of the signaling light based on the image data.

In one aspect, the one or more analysis processors are configured to edit the image data acquired during a trip of the lead vehicle to create edited image data that includes the image data representative of the condition of the one or more wayside devices and that does not include other image data.

In one aspect, the one or more analysis processors are configured to determine a location of the lead vehicle when the image data representative of the one or more wayside devices is acquired. The one or more analysis processors are configured to examine the image data representative of the one or more wayside devices and to not examine the image data acquired at one or more other locations.

In one aspect, the one or more analysis processors are configured to examine the image data from two or more previous trips of the lead vehicle and at least a secondary vehicle over a common segment of the route to identify the condition of the one or more wayside devices.

In one aspect, the one or more analysis processors are configured to determine a location of the lead vehicle when the image data representative of at least one of damage to the route, the deteriorating condition of the route, or the condition of the one or more wayside devices is obtained. The one or more analysis processors also can be configured to examine the image data representative of at least one of the damage to the route, the deteriorating condition of the route, or the condition of the one or more wayside devices at the location, but to not examine the image data acquired at one or more other locations.

In another example of the inventive subject matter described herein, a method (e.g., for imaging a wayside device) includes generating image data within a field of view of a camera disposed onboard a lead vehicle that is coupled to a secondary vehicle. The field of view includes at least a portion of the lead vehicle and one or more wayside devices disposed along a route being traveled by the lead vehicle. The method also includes examining (using one or more analysis processors) the image data generated by the camera to identify a condition of the one or more wayside devices. The condition of the one or more wayside devices includes at least one of damage to the one or more wayside devices, a missing wayside device, deterioration of the one or more wayside devices, or a change in terrain at or near the one or more wayside devices.

In one aspect, the image data is generated and examined while the lead vehicle is moving along the route.

In one aspect, the condition of the one or more wayside devices is identified based on at least one of an edge detection algorithm, pixel metrics, an object detection algorithm, baseline image data, or a pixel gradient in the image data.

In one aspect, the one or more wayside devices include a signaling light and the image data is examined to identify a broken or missing light of the signaling light based on the image data.

In one aspect, the method also includes editing the image data acquired during a trip of the lead vehicle to create edited image data that includes the image data representative of the condition of the one or more wayside devices and that does not include other image data.

In one aspect, the method also includes determining a location of the lead vehicle when the image data representative of the one or more wayside devices is acquired. The image data representative of the one or more wayside devices is examined based on the location, and the image data acquired at one or more other locations is not examined.

In one aspect, the image data is examined from two or more previous trips of the lead vehicle and at least a secondary vehicle over a common segment of the route to identify the condition of the one or more wayside devices.

In another example of the inventive subject matter described herein, another vehicle system (e.g., a secondary vehicle imaging system) includes a digital camera and one or more analysis processors. The camera is configured to be disposed in a secondary vehicle coupled to a lead vehicle and to generate image data within a field of view of the camera. The field of view includes one or more wayside devices along a route being traveled by secondary vehicle. The one or more analysis processors are configured to be disposed onboard the lead vehicle and to examine the image data generated by the camera to identify a condition of the one or more wayside devices. The condition includes at least one of damage to the one or more wayside devices, a missing wayside device, or a changing condition of terrain at or near the one or more wayside devices.

In one aspect, the digital camera is a high definition camera.

In one aspect, the one or more analysis processors are configured to identify the condition of the one or more wayside devices based on at least one of an edge detection algorithm, pixel metrics, an object detection algorithm, baseline image data, or a pixel gradient in the image data.

In one aspect, the one or more wayside devices include at least one of an inspection wayside device that inspects the secondary vehicle as the secondary vehicle moves past the inspection wayside device or a signaling wayside device that communicates information with the secondary vehicle as the secondary vehicle moves past the signaling wayside device.

In one aspect, the one or more analysis processors are configured to determine a location of the secondary vehicle when the image data representative of the condition of the one or more wayside devices is imaged.

In one example of the inventive subject matter described herein, a vehicle system (e.g., an imaging system) includes a digital camera and one or more analysis processors. The digital camera is configured to be disposed in a lead vehicle and to generate image data within a field of view of the camera. The field of view includes at least a portion of the lead vehicle and a portion of a route being traveled by the lead vehicle. The one or more analysis processors are configured to examine the image data generated by the camera to identify at least one of damage to the route or a deteriorating condition of the route.

In one aspect, the digital camera is a high definition camera.

In one aspect, the one or more analysis processors are configured to be disposed onboard the lead vehicle for examination of the image data.

In one aspect, the one or more analysis processors are configured to identify the at least one of damage to the route or the deteriorating condition of the route using at least one of edge detection algorithms or pixel metrics.

In one aspect, the one or more analysis processors are configured to identify the damage to the route as shifting of one or more supporting bodies that connect rails of the route, bending of the rails of the route, twisting of the rails of the route, or spacing between the rails of the route that differs from a designated distance.

In one aspect, the one or more analysis processors are configured to edit the image data acquired during a trip of the lead vehicle to create edited image data that includes the image data representative of the at least one of damage to the route or the deteriorating condition of the route and that does not include other image data.

In one aspect, the one or more analysis processors are configured to determine a location of the lead vehicle when the image data representative of where the at least one of damage to the route or the deteriorating condition of the route is imaged.

In one aspect, the one or more analysis processors are configured to examine the image data from two or more previous trips of the lead vehicle and at least a secondary vehicle over a common segment of the route to identify the at least one of damage to the route or the deteriorating condition of the route.

In another example of the inventive subject matter described herein, a method (e.g., an imaging method) includes generating image data within a field of view of a camera disposed onboard a lead vehicle. The field of view includes at least a portion of the lead vehicle and a portion of a route being traveled by the lead vehicle. The method also includes examining (using one or more analysis processors) the image data generated by the camera to identify at least one of damage to the route or a deteriorating condition of the route.

In one aspect, the image data is generated and examined while the lead vehicle is moving along the route.

In one aspect, the at least one of damage to the route or the deteriorating condition of the route is identified by using at least one of edge detection algorithms or pixel metrics.

In one aspect, the damage to the route is identified by the one or more analysis processors as shifting of one or more supporting bodies that connect rails of the route, bending of the rails of the route, twisting of the rails of the route, or spacing between the rails of the route that differs from a designated distance.

In one aspect, the method also includes editing the image data acquired during a trip of the lead vehicle to create edited image data that includes the image data representative of the at least one of damage to the route or the deteriorating condition of the route and that does not include other image data.

In one aspect, the method also includes determining a location of the lead vehicle when the image data representative of where the at least one of damage to the route or the deteriorating condition of the route is imaged.

In one aspect, examining the image data includes examining the image data from two or more previous trips of the lead vehicle and at least a secondary vehicle over a common segment of the route to identify the at least one of damage to the route or the deteriorating condition of the route.

In another example of the inventive subject matter described herein, another system (e.g., an imaging system) includes a digital camera and one or more analysis processors. The digital camera is configured to be disposed in a secondary vehicle and to generate image data within a field of view of the camera. The field of view includes at least a portion of the secondary vehicle. The one or more analysis processors are configured to be disposed onboard the secondary vehicle and to examine the image data generated by the camera to identify at least one of damage to the route or a deteriorating condition of the route.

In one aspect, the digital camera is a high definition camera.

In one aspect, the one or more analysis processors are configured to identify the at least one of damage to the route or the deteriorating condition of the route using at least one of edge detection algorithms or pixel metrics.

In one aspect, the one or more analysis processors are configured to identify the damage to the route as bending of rails of the route, twisting of the rails of the route, or spacing between the rails of the route that differs from a designated distance.

In one aspect, the one or more analysis processors are configured to determine a location of the secondary vehicle when the image data representative of where the at least one of damage to the route or the deteriorating condition of the route is imaged.

In one example of the inventive subject matter described herein, a system (e.g., an imaging system) includes a digital camera and one or more analysis processors. The digital camera is configured to be disposed in a lead vehicle and to generate image data within a field of view of the camera. The field of view includes at least a portion the lead vehicle and a portion of a route being traveled by the lead vehicle. The one or more analysis processors are configured to examine the image data generated by the camera to identify at least one of damage to the route or a deteriorating condition of the route.

In one aspect, the digital camera is a high definition camera.

In one aspect, the one or more analysis processors are configured to be disposed onboard the lead vehicle for examination of the image data.

In one aspect, the one or more analysis processors are configured to identify the at least one of damage to the route or the deteriorating condition of the route using at least one of edge detection algorithms or pixel metrics.

In one aspect, the one or more analysis processors are configured to identify the damage to the route as bending of rails of the route, twisting of the rails of the route, or spacing between the rails of the route that differs from a designated distance.

In one aspect, the one or more analysis processors are configured to edit the image data acquired during a trip of the lead vehicle to create edited image data that includes the image data representative of the at least one of damage to the route or the deteriorating condition of the route and that does not include other image data.

In one aspect, the one or more analysis processors are configured to determine a location of the lead vehicle when the image data representative of where the at least one of damage to the route or the deteriorating condition of the route is imaged.

In one aspect, the one or more analysis processors are configured to examine the image data from two or more previous trips of the lead vehicle and at least a secondary vehicle over a common segment of the route to identify the at least one of damage to the route or the deteriorating condition of the route.

In another example of the inventive subject matter described herein, a method (e.g., an imaging method) includes generating image data within a field of view of a camera disposed onboard a lead vehicle. The field of view includes at least a portion of the lead vehicle and a portion of a route being traveled by the lead vehicle. The method also includes examining (using one or more analysis processors) the image data generated by the camera to identify at least one of damage to the route or a deteriorating condition of the route.

In one aspect, the image data is generated and examined while the lead vehicle is moving along the route.

In one aspect, the at least one of damage to the route or the deteriorating condition of the route is identified by using at least one of edge detection algorithms or pixel metrics.

In one aspect, the damage to the route is identified by the one or more analysis processors as bending of rails of the route, twisting of the rails of the route, or spacing between the rails of the route that differs from a designated distance.

In one aspect, the method also includes editing the image data acquired during a trip of the lead vehicle to create edited image data that includes the image data representative of the at least one of damage to the route or the deteriorating condition of the route and that does not include other image data.

In one aspect, the method also includes determining a location of the lead vehicle when the image data representative of where the at least one of damage to the route or the deteriorating condition of the route is imaged.

In one aspect, examining the image data includes examining the image data from two or more previous trips of the lead vehicle and at least a secondary vehicle over a common segment of the route to identify the at least one of damage to the route or the deteriorating condition of the route.

In another example of the inventive subject matter described herein, another system (e.g., an imaging system) includes a digital camera and one or more analysis processors. The digital camera is configured to be disposed in a secondary vehicle and to generate image data within a field of view of the camera. The field of view includes at least a portion of the secondary vehicle and a portion of a route being traveled by the secondary vehicle. The one or more analysis processors are configured to be disposed onboard the secondary vehicle and to examine the image data generated by the camera to identify at least one of damage to the route or a deteriorating condition of the route.

In one aspect, the digital camera is a high definition camera.

In one aspect, the one or more analysis processors are configured to identify the at least one of damage to the route or the deteriorating condition of the route using at least one of edge detection algorithms or pixel metrics.

In one aspect, the one or more analysis processors are configured to identify the damage to the route as bending of rails of the route, twisting of the rails of the route, or spacing between the rails of the route that differs from a designated distance.

In one aspect, the one or more analysis processors are configured to determine a location of the secondary vehicle when the image data representative of where the at least one of damage to the route or the deteriorating condition of the route is imaged.

In another example of the inventive subject matter described herein, a system (e.g., an imaging system) includes a digital camera configured to be disposed in a lead vehicle. The camera is configured to generate image data within a field of view of the camera. The field of view includes at least a portion of the lead vehicle and at least one of a portion of a route being traveled by the lead vehicle or one or more wayside devices disposed along the route being traveled by the lead vehicle. The system also can include one or more analysis processors configured to examine the image data generated by the camera to identify at least one of damage to the route, a deteriorating condition of the route, or a condition of the one or more wayside devices. The condition of the one or more wayside devices includes at least one of damage to the one or more wayside devices, a missing wayside device, deterioration of the one or more wayside devices, or a change in terrain at or near the one or more wayside devices.

In one aspect, the one or more analysis processors are configured to identify at least one of the damage to the route, the deteriorating condition of the route, or the condition of the one or more wayside devices based on at least one of an edge detection algorithm, pixel metrics, an object detection algorithm, baseline image data, or a pixel gradient in the image data.

In one aspect, the one or more analysis processors are configured to edit the image data acquired during a trip of the lead vehicle to create edited image data that includes the image data representative of the at least one of the damage to the route, the deteriorating condition of the route, or the condition of the one or more wayside devices but that does not include other image data.

In one aspect, the one or more analysis processors are configured to determine a location of the lead vehicle when the image data representative of at least one of damage to the route, the deteriorating condition of the route, or the condition of the one or more wayside devices is obtained. The one or more analysis processors also can be configured to examine the image data representative of at least one of damage to the route, a deteriorating condition of the route, or a condition of the one or more wayside devices, the condition of the one or more wayside devices including at least one of damage to the one or more wayside devices but to not examine the image data acquired at one or more other locations.

In another example of the inventive subject matter described herein, another method (e.g., an imaging method) includes generating image data within a field of view of a camera disposed onboard a lead vehicle. The field of view includes at least a portion of the lead vehicle and at least one of a portion of a route being traveled by the lead vehicle or one or more wayside devices disposed along the route being traveled by the lead vehicle. The method also can include examining, using one or more analysis processors, the image data generated by the camera to identify at least one of damage to the route, a deteriorating condition of the route, or a condition of the one or more wayside devices. The condition includes at least one of damage to the one or more wayside devices, a missing wayside device, deterioration of the one or more wayside devices, or a change in terrain at or near the one or more wayside devices.

In one aspect, the at least one of damage to the route, the deteriorating condition of the route, or the condition of the one or more wayside devices is identified based on at least one of an edge detection algorithm, pixel metrics, an object detection algorithm, baseline image data, or a pixel gradient in the image data.

In one aspect, the method also includes editing the image data acquired during a trip of the lead vehicle to create edited image data that includes the image data representative of the at least one of damage to the route, the deteriorating condition of the route, or the condition of the one or more wayside devices but does not include other image data.

In one aspect, the method also includes determining a location of the lead vehicle when the image data representative of the at least one of damage to the route, the deteriorating condition of the route, or the condition of the one or more wayside devices is generated. The image data that is representative of the at least one of damage to the route, the deteriorating condition of the route, or the condition of the one or more wayside devices is examined based on the location and the image data acquired at one or more other locations is not examined.

In another example of the inventive subject matter described herein, another system (e.g., an imaging system) includes a digital camera configured to be disposed in a secondary vehicle. The camera is configured to generate image data within a field of view of the camera. The field of view includes at least a portion of the secondary vehicle and at least one of a portion of a route outside of the secondary vehicle or one or more wayside devices along the route being traveled by the secondary vehicle. The system also includes one or more analysis processors configured to be disposed onboard the secondary vehicle and to examine the image data generated by the camera to identify a condition of at least one of the route or the one or more wayside devices. The condition includes at least one of damage to the route, damage to the one or more wayside devices, a missing wayside device, or a changing condition of terrain at or near the one or more wayside devices.

In one aspect, the one or more analysis processors are configured to identify the condition of at least one of the route or the one or more wayside devices based on at least one of an edge detection algorithm, pixel metrics, an object detection algorithm, baseline image data, or a pixel gradient in the image data.

In one aspect, the one or more analysis processors are configured to determine a location of the secondary vehicle when the image data representative of the condition of at least one of the route or the one or more wayside devices is imaged.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are exemplary embodiments. Many other embodiments will be apparent to one of ordinary skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose several embodiments of the inventive subject matter and also to enable a person of ordinary skill in the art to practice the embodiments of the inventive subject matter, including making and using any devices or systems and performing any incorporated methods. The patentable scope of the inventive subject matter is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

The foregoing description of certain embodiments of the inventive subject matter will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, processors or memories) may be implemented in a single piece of hardware (for example, a general purpose signal processor, microcontroller, random access memory, hard disk, and the like). Similarly, the programs may be stand-alone programs, may be incorporated as subroutines in an operating system, may be functions in an installed software package, and the like. The various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the inventive subject matter are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

What is claimed is:

1. A locomotive system comprising:
a locomotive and a rail vehicle coupled to the locomotive;
a digital camera configured to be disposed in the locomotive system, the camera configured to generate image data within a field of view of the camera, the field of view including at least a portion of a cab of the locomotive system and at least one of a portion of a route being traveled by the locomotive system or one or more wayside devices disposed along the route being traveled by the locomotive system, the cab including a space where an operator of the locomotive system is located during travel of the locomotive system; and
one or more analysis processors configured to examine the image data generated by the camera to identify at least one of damage to the route, a deteriorating condition of the route, or a condition of the one or more wayside devices, the condition of the one or more wayside devices including at least one of damage to the one or more wayside devices, a missing wayside device, deterioration of the one or more wayside devices, or a change in terrain at or near the one or more wayside devices.

2. The system of claim 1, wherein the digital camera is a high definition camera.

3. The system of claim 1, wherein the one or more analysis processors are configured to be disposed onboard the locomotive system for examination of the image data.

4. The system of claim 1, wherein the one or more analysis processors are configured to identify at least one of the damage to the route, the deteriorating condition of the route, or the condition of the one or more wayside devices based on at least one of an edge detection algorithm, pixel metrics, an object detection algorithm, baseline image data, or a pixel gradient in the image data.

5. The system of claim 1, wherein the one or more wayside devices include a signaling light and the one or more analysis processors are configured to identify a broken or missing light of the signaling light based on the image data.

6. The system of claim 1, wherein the one or more analysis processors are configured to identify the damage to the route as bending of rails of the route, twisting of the rails of the route, or a spacing between the rails of the route that differs from a designated distance.

7. The system of claim 1, wherein the one or more analysis processors are configured to edit the image data acquired during a trip of the locomotive system to create edited image data that includes the image data representative of the at least one of the damage to the route, the deteriorating condition of the route, or the condition of the one or more wayside devices but that does not include other image data.

8. The system of claim 1, wherein the one or more analysis processors are configured to determine a location of the locomotive system when the image data representative of at least one of damage to the route, the deteriorating condition of the route, or the condition of the one or more wayside devices is obtained, and the one or more analysis processors are configured to examine the image data representative of at least one of the damage to the route, the deteriorating condition of the route, or the condition of the one or more wayside devices at the location, but to not examine the image data acquired at one or more other locations.

9. A method comprising:
generating image data within a field of view of a camera disposed onboard a locomotive system that includes a locomotive coupled to a rail vehicle, the field of view including at least a portion of a cab of the locomotive system and at least one of a portion of a route being traveled by the locomotive system or one or more wayside devices disposed along the route being traveled by the locomotive system, the cab including a space where an operator of the locomotive system is located during travel of the locomotive system; and
examining, using one or more analysis processors, the image data generated by the camera to identify at least one of damage to the route, a deteriorating condition of the route, or a condition of the one or more wayside devices, the condition of the one or more wayside devices including at least one of damage to the one or more wayside devices, a missing wayside device, deterioration of the one or more wayside devices, or a change in terrain at or near the one or more wayside devices.

10. The method of claim 9, wherein the image data is generated and examined while the locomotive system is moving along the route.

11. The method of claim 9, wherein the at least one of damage to the route, the deteriorating condition of the route, or the condition of the one or more wayside devices is identified based on at least one of an edge detection algorithm, pixel metrics, an object detection algorithm, baseline image data, or a pixel gradient in the image data.

12. The method of claim 9, wherein the one or more wayside devices include a signaling light and the image data is examined to identify a broken or missing light of the signaling light based on the image data.

13. The method of claim 9, wherein the damage to the route is identified by the one or more analysis processors as bending of rails of the route, twisting of the rails of the route, or a spacing between the rails of the route that differs from a designated distance.

14. The method of claim 9, further comprising editing the image data acquired during a trip of the locomotive system to create edited image data that includes the image data representative of the at least one of damage to the route, the deteriorating condition of the route, or the condition of the one or more wayside devices but does not include other image data.

15. The method of claim 9, further comprising determining a location of the locomotive system when the image data representative of the at least one of damage to the route, the deteriorating condition of the route, or the condition of the one or more wayside devices is generated, wherein the image data representative of the at least one of damage to the route, the deteriorating condition of the route, or the condition of the one or more wayside devices is examined based on the location and the image data acquired at one or more other locations is not examined.

16. A locomotive system comprising:
a locomotive coupled to a rail vehicle;
a digital camera configured to be disposed in the rail vehicle, the camera configured to generate image data within a field of view of the camera, the field of view including at least one of a portion of a track outside of the rail vehicle or one or more wayside devices along the track being traveled by the locomotive; and
one or more analysis processors configured to be disposed onboard the locomotive and to examine the image data generated by the camera to identify a condition of at least one of the track or the one or more wayside devices, the condition including at least one of damage to the track, damage to the one or more wayside devices, a missing wayside device, or a changing condition of terrain at or near the one or more wayside devices.

17. The system of claim 16, wherein the digital camera is a high definition camera.

18. The system of claim 16, wherein the one or more analysis processors are configured to identify the condition of the at least one of the track or the one or more wayside devices based on at least one of an edge detection algorithm, pixel metrics, an object detection algorithm, baseline image data, or a pixel gradient in the image data.

19. The system of claim 16, wherein the one or more wayside devices include at least one of an inspection wayside device that inspects the locomotive as the locomotive moves past the inspection wayside device or a signaling wayside device that communicates information with the locomotive as the locomotive moves past the signaling wayside device.

20. The system of claim 16, wherein the one or more analysis processors are configured to determine a location of the locomotive when the image data representative of the condition of the at least one of the track or the one or more wayside devices is imaged.
